(19) United States
(12) Patent Application Publication
(10) Pub. No.: US 2020/0104881 A1
(43) Pub. Date: Apr. 2, 2020

(54) VEHICLE CONTROL SYSTEM, VEHICLE CONTROL METHOD, PROGRAM, AND VEHICLE MANAGEMENT SYSTEM

(71) Applicant: HONDA MOTOR CO., LTD., Minato-ku, Tokyo (JP)

(72) Inventors: Yuji Yasui, Wako-shi (JP); Shion Tokunaga, Wako-shi (JP); Nobuyuki Watanabe, Wako-shi (JP); Kazuki Nishioka, Wako-shi (JP); Yudai Hirohata, Wako-shi (JP); Hisakazu Yamane, Tokyo (JP); Takayuki Shimoyamada, Tokyo (JP)

(21) Appl. No.: 16/621,456

(22) PCT Filed: Jun. 15, 2018
(86) PCT No.: PCT/JP2018/022919

§ 371 Date: Dec. 11, 2019

(30) Foreign Application Priority Data
Jun. 16, 2017 (JP) 2017-118719

(51) Int. Cl. G06Q 30/02; G06K 9/00; G09F 21/04; G05D 1/00

(52) U.S. Cl. CPC G06Q 30/0266; G06K 9/00805; G05D 1/0088; G09F 21/04; G06K 9/00362

(57) ABSTRACT

A vehicle control system includes an outside display provided on the exterior of a vehicle and configured to display content toward the outside of the vehicle, a vehicle environment acquirer configured to acquire an environment of the vehicle, and a display controller configured to control display of the content on the outside display on the basis of the environment of the vehicle acquired by the vehicle environment acquirer.

### TECHNICAL FIELD

Embodiments of the present invention relate to a vehicle control system, a vehicle control method, a program and a vehicle management system.

Priority is claimed on Japanese Patent Application No. 2017-118719, filed Jun. 16, 2017, the content of which is incorporated herein by reference.

### BACKGROUND ART

Conventionally, a technology for displaying traffic information on an outside display device provided in a vehicle to transmit traffic information to the surroundings of the vehicle is known (refer to Patent Document 1, for example). Patent Document 1 discloses a signal information transmission system including a road device which transmits signal information of a traffic signal installed on a road, a reception device which is mounted on a vehicle and receives signal information transmitted by the road device, a conversion device which converts the signal information received by the reception device into a visually presentable information form, and a display device disposed on a rear side of the vehicle and displaying information converted by the conversion device.

### CITATION LIST

### Patent Literature

### [Patent Document 1]

Japanese Unexamined Patent Application, First Publication No. 2004-362064

### SUMMARY OF INVENTION

### Technical Problem

However, there are cases in which content that an occupant desires to display cannot be displayed outside a vehicle in accordance with an environment of the vehicle in conventional technologies.

An object of the present invention devised in view of the aforementioned circumstances is to provide a vehicle control system, a vehicle control method, a program, and a vehicle management system which can realize display of content to the outside of a vehicle in a state suitable for an environment of the vehicle.

### Solution to Problem

(1): One aspect of the present invention is a vehicle control system including: an outside display (272) provided on the exterior of a vehicle (200) and configured to display content toward an outside of the vehicle; a vehicle environment acquirer (210, 245) configured to acquire an environment of the vehicle; and a display controller (270) configured to control display of the content on the outside display on the basis of the environment of the vehicle acquired by the vehicle environment acquirer.

(2): In the aspect of (1), the vehicle environment acquirer derives a degree of attention on the vehicle, and the display controller is configured to display second content when the degree of attention exceeds a predetermined value after first content is displayed on the outside display.

(3): In the aspect of (2), the second content includes advertisement information.

(4): In any one of the aspects of (1) to (3), the vehicle control system further includes an automated driving controller (250) configured to execute automated driving of the vehicle, and the automated driving controller is configured to control a speed of the vehicle in connection with the display of the content by the display controller.

(5): In any one of the aspects of (1) to (4), the display controller is configured to control the display of the content depending on a travel state of the vehicle.

(6): In any one of the aspects of (1) to (5), the display controller is configured to control the display of the content depending on a state of an occupant of the vehicle acquired by the vehicle environment acquirer.

(7): In any one of the aspects of (1) to (6), the vehicle environment acquirer is configured to monitor a line of sight of a person around the vehicle, and the display controller is configured to change positions of objects included in the content on the basis of the line-of-sight direction of the person around the vehicle acquired by the vehicle environment acquirer.

(8): In any one of the aspects of (1) to (7), the vehicle control system further includes: a communicator (220) configured to perform communication with a content providing server; and a requester (274) configured to transmit a content request that causes the content providing server to transmit the content, using the communicator, and the display controller is configured to display the content acquired from the content providing server on the outside display according to the request from the requester.

(9): Another aspect of the present invention is a vehicle control method comprising, using a computer: displaying content to an outside of a vehicle through an outside display provided on an exterior of the vehicle; acquiring an environment of the vehicle; and controlling the display of the content on the outside display on the basis of the acquired environment of the vehicle.

(10): Another aspect of the present invention is a program causing a computer to: display content toward an outside of a vehicle through an outside display provided on an exterior of the vehicle; acquire an environment of the vehicle; and control the display of the content on the outside display on the basis of the acquired environment of the vehicle.

(11): Another aspect of the present invention is a vehicle management system including: a content controller configured to control content displayable on an outside display provided on an exterior of a vehicle and displaying content toward an outside of the vehicle; an acquirer configured to acquire environment information of the vehicle from the vehicle; and a referencer configured to refer to a corresponding relationship between a user of the vehicle or an operator of the vehicle and the content during travel of the vehicle, and the content controller is configured to permit use of the content on the basis of a reference result of the referencer.

(12) In the aspect of (11), the acquirer is configured to acquire display content being displayed on the outside display and a degree of attention on the vehicle, and the vehicle management system includes an updater configured to update the corresponding relationship between the user of the vehicle or the operator of the vehicle and the content.

(13) In the aspect of (11), the content includes advertisement information.

(14) In the aspect of (11), the acquirer is configured to acquire information representing whether an automated driving controller of the vehicle is executing automated driving control and information on content display on the outside display of the vehicle, and the vehicle management system includes an indicator configured to request change of travel states or routes for the automated driving controller on the basis of the content acquired by the acquirer when the vehicle is executing the automated driving control.

(15) In the aspect of (14), the indicator further requests is configured to change of the travel states or routes depending on the environment information of the vehicle acquired by the acquirer.

(16) In the aspect of (11), the referencer refers to the corresponding relationship between the content and the user of the vehicle or between the operator of the vehicle and the content depending on a state of an occupant of the vehicle acquired by the acquirer.

(17) In the aspect of (11), the acquirer is configured to acquire a line of sight of a person around the vehicle associated with content being displayed on the outside display and a position at which the content is displayed on the outside display as environment information of the vehicle, and the vehicle management system includes an updater configured to update a corresponding relationship between a user of the vehicle or an operator of the vehicle and the content on the basis of the acquired environment information.

(18) In the aspect of (11), the vehicle management system further includes: a communicator configured to perform communication with a content providing server; a requester configured to cause the communicator to transmit a content request for requesting the content to the content providing server; and an updater configured to update a corresponding relationship between content acquired from the content providing server and the user of the vehicle or the operator of the vehicle during the travel of the vehicle according to a request from the requester.

### Advantageous Effects of Invention

According to (1) to (18), it is possible to realize display of content to the outside of a vehicle in a state suitable for an environment of the vehicle.

### BRIEF DESCRIPTION OF DRAWINGS

FIG. 1 is a configuration diagram of a vehicle control system 1 of an embodiment.

FIG. 2 is a configuration diagram of a vehicle 200 of an embodiment.

FIG. 3 is a diagram for describing a processing procedure of automated driving.

FIG. 4 is a diagram showing an example of a content acquisition request screen IM1.

FIG. 5 is a diagram showing an example of details of content data 342 for each vehicle.

FIG. 6 is a diagram showing an example of details of advertisement information 344 for each vehicle type.

FIG. 7 is a diagram showing an example of details of user information 346.

FIG. 8 is a diagram showing an example of a content acquisition result screen IM2.

FIG. 9 is a diagram showing an example of details of display conditions data 278A.

FIG. 10 is a diagram for describing a state in which content is displayed on an outside display 272.

FIG. 11 is a diagram for describing speed control of a vehicle 200.

FIG. 12 is a diagram for describing display control of advertisement information.

FIG. 13 is a flowchart showing an example of a processing flow executed by the vehicle 200.

FIG. 14 is a configuration diagram of a service providing system 2 including the vehicle 200 according to a second embodiment.

FIG. 15 is a diagram showing an example of a configuration of a vehicle management device 210 mounted in the vehicle 200.

FIG. 16 is a diagram showing an example of a configuration of a service provider device 600.

FIG. 17 is a diagram showing an example of a configuration of a service management device 700.

FIG. 18 is a diagram showing an example of details of corresponding information 838.

FIG. 19 is a diagram for describing processing of an updater 744.

FIG. 20 is a flowchart showing an example of a processing flow executed in the service providing system 2.

FIG. 21 is a diagram showing an example of a perspective view of a vehicle providing a service.

FIG. 22 is a diagram showing an example of a diagram of a vehicle providing a service viewed in the lateral direction.

FIG. 23 is an example of a perspective view of the vehicle 200.

FIG. 24 is a diagram of the vehicle 200 viewed in the lateral direction.

FIG. 25 is an example of a perspective view of the vehicle 200.

FIG. 26 is a diagram of the vehicle 200 viewed in the lateral direction.

FIG. 27 is an example of a perspective view of the vehicle 200.

FIG. 28 is a diagram of the vehicle 200 viewed in the lateral direction.

FIG. 29 is a diagram of a vehicle viewed from the rear side.

FIG. 30 is a perspective view of the vehicle 200.

### DESCRIPTION OF EMBODIMENTS

Hereinafter, embodiments of a vehicle control system, a vehicle control method, a program, and a vehicle management system of the present invention will be described with reference to the drawings. A vehicle controlled by the vehicle control system is, for example, an automated driving vehicle which does not require a driving operation basically. Although description will be made on the assumption that an automated driving vehicle is used hereinafter, a non-automated driving vehicle may be used.

### First Embodiment

### [Overall Configuration]

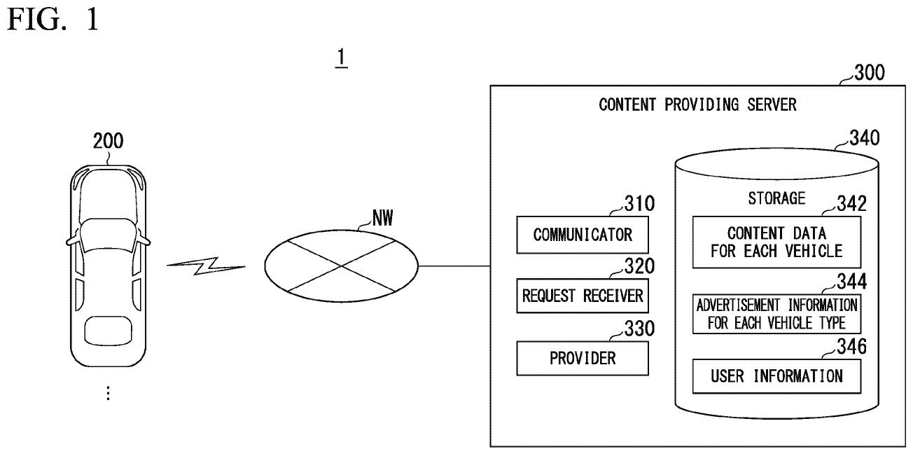

FIG. 1 is a configuration diagram of a vehicle control system 1 of an embodiment. The vehicle control system 1 includes one or more vehicles 200 and a content providing server 300. These components can communicate with each other through a network NW. The network NW includes the Internet, a wide area network (WAN), a local area network (LAN), a public line, a provider device, a dedicated line, a wireless base station, and the like.

### [Vehicle]

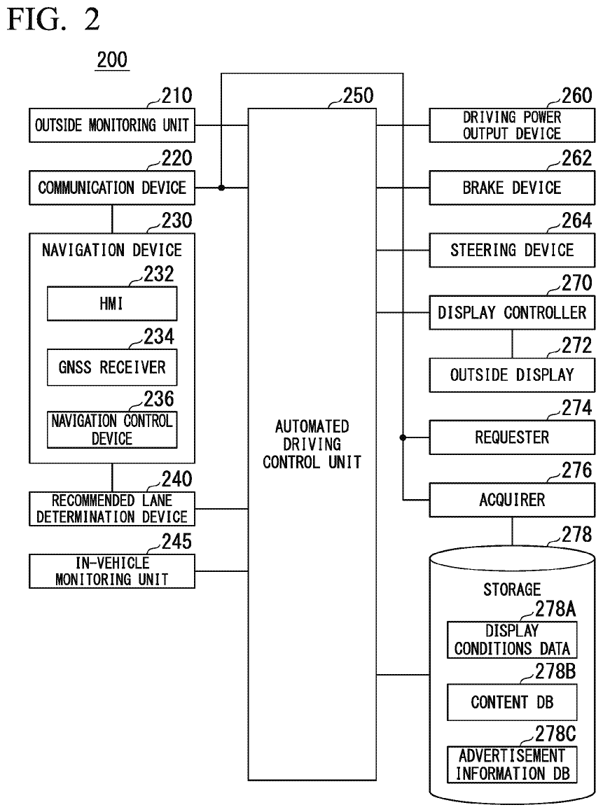

Although the vehicle 200 is, for example, a vehicle having four or more wheels in which a user can ride, it may be automated two-wheeled vehicles and other vehicles. FIG. 2 is a configuration diagram of the vehicle 200 of an embodiment. The vehicle 200 includes, for example, an outside monitoring unit 210, a communication device (communicator) 220, a navigation device 230, a recommended lane determination device 240, an in-vehicle monitoring unit 245, an automated driving control unit 250, a driving power output device 260, a brake device 262, a steering device 264, a display controller 270, an outside display 272, a requester 274, an acquirer 276, and a storage 278. For example, the automated driving control unit 250, the display controller 270, the requester 274 and the acquirer 276 may include processors such as central processing units (CPUs) which execute programs (software) stored in the storage 278 in the vehicle 200. Some or all of these functional parts may be realized by hardware such as a large scale integration (LSI) circuit, an application specific integrated circuit (ASIC), a field-programmable gate array (FPGA) and a graphics processing unit (GPU) or realized by software and hardware in cooperation. Programs may be stored in advance in a storage device such as a hard disk drive (HDD) or flash memory or stored in a detachable storage medium such as a DVD or a CD-ROM and installed in a storage device when the storage medium is set in a drive device. Some or all of the outside monitoring unit 210 and the in-vehicle monitoring unit 245 are an example of a “vehicle environment acquirer.” The automated driving control unit 250 is an example of an “automated driving controller.”

The outside monitoring unit 210 includes, for example, a camera, a radar, a light detection ranging (LIDAR) device, an object recognition device which performs sensor fusion processing on the basis of outputs of these components, and the like. The outside monitoring unit 210 estimates types of objects (particularly, vehicles, pedestrians and bicycles) around the vehicle 200 and outputs the estimated types along with information on positions and speeds thereof to the automated driving control unit 250.

When an object present around the vehicle 200 is a person, the outside monitoring unit 210 monitors a line of sight of the person on the basis of an image from the camera and derives a degree of attention on the vehicle 200 on the basis of a line-of-sight direction of the monitored person. For example, when it is determined that there is no person whose line-of-sight direction faces the vehicle 200, the outside monitoring unit 210 sets the degree of attention to “0.” The outside monitoring unit 210 sets the degree of attention to “1” when the number of persons whose line-of-sight directions faces the vehicle 200 is less than a predetermined number (e.g., 3) and sets the degree of attention to “2” when the number of persons whose line-of-sight directions faces the vehicle 200 is equal to or greater than the predetermined number. The outside monitoring unit 210 outputs information about a line-of-sight direction of a person and the degree of attention on the vehicle 200 to the display controller 270.

The communication device 220 is, for example, a wireless communication module for accessing the network NW to communicate with the content providing server 300 or directly communicating with other vehicles, terminal devices of pedestrians, or the like. The communication device 220 performs wireless communication on the basis of Wi-Fi, dedicated short range communications (DSRC), Bluetooth (registered trademark) and other communication standards. A plurality of communication devices for purposes may be provided as the communication device 220.

The navigation device 230 includes, for example, a human machine interface (HMI) 232, a global navigation satellite system (GNSS) receiver 234, and a navigation control device 236.

The HMI 232 includes, for example, a touch panel type display device (display), a speaker, a microphone, various operation switches, and the like. The HMI 232 outputs images and audio and receives details of operations from occupants. For example, the HMI 232 may display information for promoting operation of an occupant for the vehicle 200 on a screen or output the information through audio. The HMI 232 displays a content acquisition request screen, a content acquisition result screen, and the like and receives an operation of an occupant for a displayed screen. Content may be an image, for example. Content includes one or more objects. For example, an object may be an image of a personality or a mascot, an image of a character in an animation, an image of an animal, or the like. These images are images for which publication rights such as copyrights have been cleared. An object may represent a picture, a letter, a symbol, a shape, a pattern or the like as an image. Content may be a video which causes an object to act using a plurality of images. The HMI 232 transmits an acquisition request for content operated by an occupant, and the like to the content providing server 300.

The GNSS receiver 234 identifies the position thereof (the position of the vehicle 200) on the basis of radio waves received from a GNSS satellite (e.g., GPS satellite). The navigation control device 236 includes, for example, a central processing unit (CPU) and various storage devices and controls the entire navigation device 230. Map information (navigation maps) is stored in storage devices. Navigation maps are maps which represent roads using nodes and links.

The navigation control device 236 may self-determine a route from the position of the vehicle 200 identified by the GNSS receiver 234 to a destination designated using the HMI 232 with reference to navigation maps. The navigation control device 236 outputs information on the route determined through any method to the recommended lane determination device 240.

The recommended lane determination device 240 includes, for example, a micro-processing unit (MPU) and various storage devices. Map information with higher accuracy than that of navigation maps is stored in storage devices. Map information with higher accuracy includes, for example, information on a road width, gradient and curvature of each lane, positions of signals, and the like. The recommended lane determination device 240 determines recommended lanes desirable for traveling along a route input from the navigation device 230 and outputs the recommended lanes to the automated driving control unit 250.

The in-vehicle monitoring unit 245 includes, for example, a camera, a load sensor provided in a seat on which an occupant sits, an occupant recognition device which performs sensor fusion processing on the basis of outputs of these components, and the like. The in-vehicle monitoring unit 245 acquires information about the number of occupants in a vehicle cabin, sitting positions of occupants, and occupant states and outputs the acquired information to the display controller 270. Occupant states are, for example, a state in which an occupant is sleeping or awake, and the like.

The automated driving control unit 250 includes one or more processors such as a CPU and a micro-processing unit (MPU) and various storage devices. The automated driving control unit 250 causes the vehicle 200 to automatically travel such that the vehicle 200 avoids contact with objects whose positions and speeds have been input from the outside monitoring unit 210 on the principle of traveling in recommended lanes determined by the recommended lane determination device 240. The automated driving control unit 250 may sequentially execute various events, for example. Events include a constant-speed travel event of traveling in the same travel lane at a constant speed, a following travel event of following a preceding vehicle, a lane change event, a merging event, a branch event, an emergency stop event, a tollgate event for passing through a tollgate, a handover event for ending automated driving and switching to non-automated driving, and the like. There is also a case in which an action for avoidance may be planned on the basis of surrounding situations (presence of neighboring vehicles and pedestrians, lane narrowing due to road construction, and the like) of the vehicle 200 during execution of such events.

The automated driving control unit 250 generates a target trajectory through which the vehicle 200 will travel in the future. A target trajectory includes, for example, a speed factor. For example, a target trajectory may be represented as sequential arrangement of points (trajectory points) at which a host vehicle M will arrive. A trajectory point is a point at which the host vehicle M will arrive for each predetermined traveling distance, and a target speed and a target acceleration for each predetermined sampling time (e.g., approximately zero comma several seconds) are generated as a part of a target trajectory apart from trajectory points. A trajectory point may be a position at which the host vehicle M will arrive at a sampling time for each predetermined sampling time. In this case, information on a target speed and a target acceleration is represented as intervals between trajectory points.

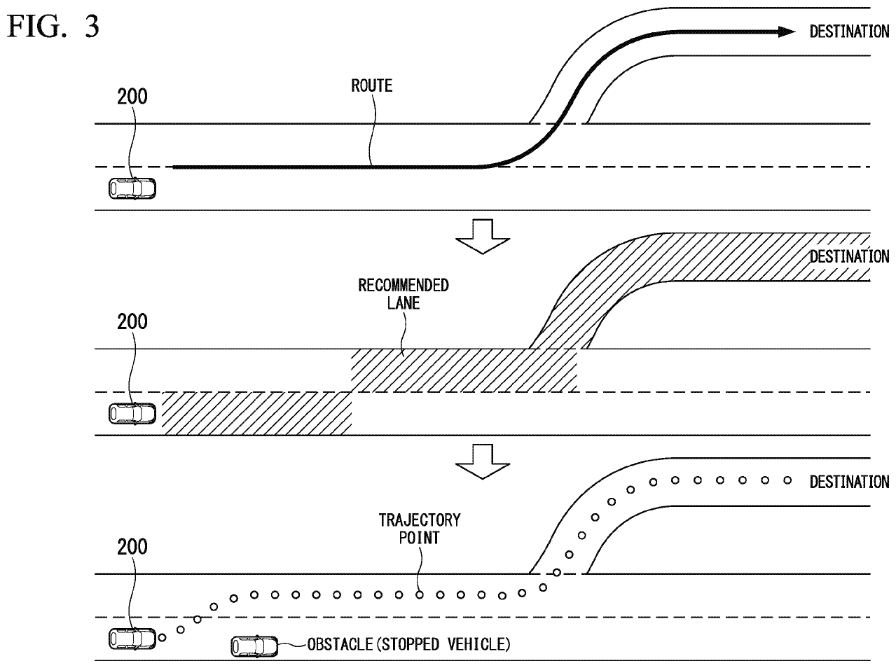

FIG. 3 is a diagram for describing a processing procedure of automated driving. First, the navigation device 230 determines a route as shown in the upper figure. This route is, for example, a rough route on which lanes are not discriminated. Next, the recommended lane determination device 240 determines recommended lanes in which the vehicle easily travels along the route as shown in the middle figure. Then, the automated driving control unit 250 generates trajectory points for traveling along the recommended lanes as long as possible while avoiding obstacles and the like and controls some or all of the driving power output device 260, the brake device 262 and the steering device 264 such that the vehicle travels along the trajectory points (and an associated speed profile) as shown in the lower figure. Such distribution of roles is merely an example and, for example, the automated driving control unit 250 may perform processing in an integrated manner.

The driving power output device 260 outputs a travel driving power (torque) for traveling of the vehicle to driving wheels. The driving power output device 260 includes, for example, a combination of an internal combustion engine, a motor, a transmission and the like, and a power electronic control unit (ECU) which controls these components. The power ECU controls the aforementioned components according to information input from the automated driving control unit 250 or information input from a driving operator which is not shown.

The brake device 262 includes, for example, a brake caliper, a cylinder which transfers a hydraulic pressure to the brake caliper, an electric motor which generates a hydraulic pressure in the cylinder, and a brake ECU. The brake ECU controls the electric motor according to information input from the automated driving control unit 250 or information input from the driving operator such that a brake torque according to the braking operation is output to each vehicle wheel. The brake device 262 may include a mechanism for transferring a hydraulic pressure generated by an operation of the brake pedal included in the driving operator to the cylinder through a master cylinder as a backup. The brake device 262 is not limited to the above-described configuration and may be an electronically controlled hydraulic brake device which controls an actuator according to information input from the automated driving control unit 250 and transfers a hydraulic pressure of a master cylinder to a cylinder.

The steering device 264 includes, for example, a steering ECU and an electric motor. For example, the electric motor may change the direction of the steering wheel by applying a force to a rack-and-pinion mechanism. The steering ECU drives the electric motor according to information input from the automated driving control unit 250 or information input from the driving operator to change the direction of the steering wheel.

The display controller 270 controls the outside display 272 such that the outside display 272 displays content included in a content DB 278B stored in the storage 278 and advertisement information included in an advertisement information DB 278C on the basis of display conditions data 278A stored in the storage 278. The advertisement information is information presented around products, services and the like acquired from advertisers by the content providing server 300. The content included in the content DB 278B is an example of “first content.” The advertisement information is an example of “second content.” Functions of the display controller 270 will be described in detail later.

The outside display 272 is, for example, an organic electroluminescence display attached to the surface of a body part on the outer side of the vehicle 200. The outside display 272 may be a liquid crystal display (LCD) fitted in the body part or a display panel configured as the entire body part or a part thereof. The outside display 272 may be a portable display device including a driver. In this case, the outside display 272 is stored at a position at which a display surface thereof is not viewed from the outside of the vehicle when content is not displayed thereon and moved by the driver to a position at which the display surface is viewed from the outside of the vehicle when content is displayed thereon. The outside display 272 may be a light transmission type liquid crystal panel formed on at least a part of the front windshield, side windshield and rear windshield of the vehicle 200. The aforementioned body part and various windshields are an example of “exterior.”

The requester 274 performs a content acquisition request for the content providing server 300 through the communication device 220 when a content request operation is received from an occupant of the vehicle 200. The requester 274 may perform a content acquisition request for the content providing server 300 at predetermined time intervals. The requester 274 may perform an advertisement information acquisition request for the content providing server 300. Functions of the requester 274 will be described in detail later.

The acquirer 276 acquires content requested through the requester 274 from the content providing server 300. When a plurality of pieces of content have been acquired, the acquirer 276 may select one or more pieces of content therefrom. The acquirer 276 stores acquired content in the content DB 278B stored in the storage 278. The acquirer 276 acquires advertisement information provided by the content providing server 300 and stores the acquired advertisement information in the advertisement information DB 278C stored in the storage 278.

The storage 278 is realized by a hard disk drive (HDD), a flash memory, a random access memory (RAM), a read only memory (ROM) or the like. The storage 278 stores, for example, the display conditions data 278A, the content DB 278B, the advertisement information DB 278C, and other types of information. The content DB 278B is, for example, information in which a content identification ID for identifying content is associated with the content. The advertisement information DB 278C is, for example, information in which an advertisement identification ID for identifying advertisement information is associated with the advertisement information.

### [Content Providing Server]

Referring back to FIG. 1, the content providing server 300 includes, for example, a communicator 310, a request receiver 320, a provider 330 and a storage 340. The request receiver 320 and the provider 330 is realized, for example, by a processor such as a CPU executing a program (software) stored in the storage 340. Some or all of these functional parts may be realized by hardware such as an LSI circuit, an ASIC, an FPGA and a GPU or realized by software and hardware in cooperation.

The communicator 310 is, for example, a network card for accessing the network NW. The communicator 310 communicates with the vehicle 200 and other external devices through the network NW.

The request receiver 320 receives a content acquisition request from the vehicle 200. The request receiver 320 may receive an advertisement information acquisition request from the vehicle 200.

The provider 330 refers to content data 342 for each vehicle stored in the storage 340 on the basis of a content request received by the request receiver 320 and extracts content data which corresponds to a vehicle 200 that has transmitted the content acquisition request and satisfies the request. The provider 330 transmits the extracted content data to the vehicle 200 that has transmitted the content request.

The provider 330 refers to advertisement information 344 for each vehicle type stored in the storage 340, acquires advertisement information associated with a vehicle type (e.g., a box car, a minivan, or a truck) of a vehicle 200 that has transmitted a content request, and transmits the acquired advertisement information to the vehicle 200 that has transmitted the content request. Advertisement information may be acquired at a timing at which a content acquisition request is received by the request receiver 320, a timing at which an advertisement information acquisition request is received, or other predetermined timings (e.g., a predetermined period).

The provider 330 stores a content provision history in the storage 340 as user information 346. The provider 330 may transmit special content to the vehicle 200 on the basis of the number of times of utilization of a user (the number of times of providing content) and other types of information with reference to the user information 346. The special content is, for example, “rare content” such as content that cannot be acquired through a normal content request or content for which the number of provisions is limited. Functions of the provider 330 will be described in detail later.

The storage 340 is realized by an HDD, a flash memory, a RAM, a ROM or the like. The storage 340 stores, for example, the content data 342 for each vehicle, the advertisement information 344 for each vehicle type, the user information 346, and other types of information. Data stored in the content data 342 for each vehicle and the advertisement information 344 for each vehicle type is, for example, data updated according to instructions from a server manager or other external devices at any time.

### [Details of Specific Processing in Vehicle Control System 1 of Embodiment]

Hereinafter, details of specific processing in the vehicle control system 1 of an embodiment will be described.

### [Acquisition of Content and Advertisement Information]

First, an example of acquisition of content and advertisement information in an embodiment will be described. An occupant of the vehicle 200 acquires content and advertisement information to be displayed on the outside display 272 from the content providing server. In this case, the requester 274 causes a display of the HMI 232 to display a content acquisition request screen IM1 and allows the occupant to perform an operation for acquiring the content.

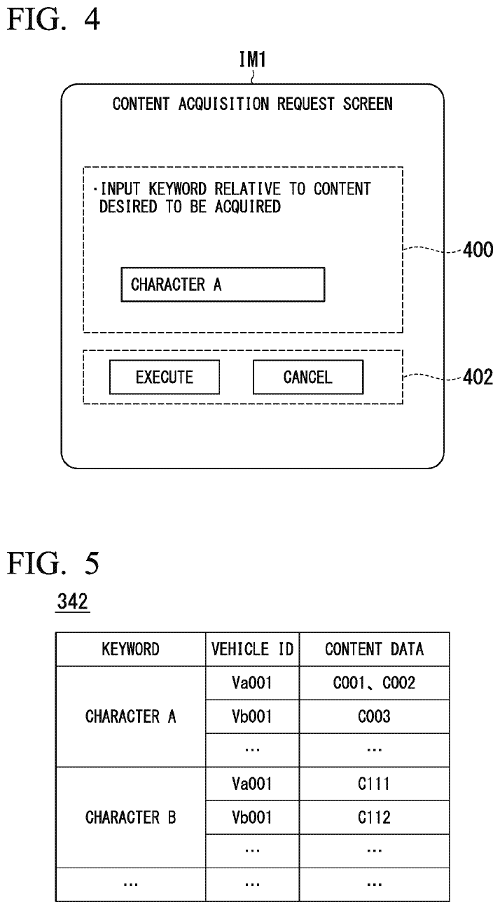

FIG. 4 is a diagram showing an example of the content acquisition request screen IM1. The content acquisition request screen IM1 displays a keyword input area 400 through which a keyword about content desired to be acquired is input, and a determination operation area 402 through which execution or cancellation of a content acquisition request based on input details is determined. A layout of the content acquisition request screen IM1 is not limited to the example of FIG. 4 with respect to display items. Layouts and items with respect to other screens IMx (x is a natural number equal to or greater than 2) described below may also be arbitrarily changed. Various screens displayed on displays of the vehicle 200 may be displayed, for example, on a display of a terminal device used by an occupant. The terminal device is, for example, a smartphone, a tablet terminal, or a personal computer.

An occupant inputs a keyword to the keyword input area 400 of the content acquisition request screen IM1. The keyword is, for example, information about the name of a character or the genre of content, or the like. The occupant selects an execution button of the determination operation area 402 after input of the keyword. Accordingly, the requester 274 transmits a content acquisition request including the input keyword and a vehicle identification ID for identifying the vehicle 200 to the content providing server 300. The vehicle identification ID may include information for identifying a vehicle type. For example, when the vehicle identification ID is “Va001,” “Va” may be vehicle type identification information.

The request receiver 320 of the content providing server 300 outputs the keyword and the identification information of the vehicle included in the content acquisition request to the provider 330 when the content acquisition request transmitted from the vehicle 200 is received. The provider 330 acquires content associated with content data 342 for each vehicle, the keyword and the identification information of the vehicle on the basis of the keyword and the identification information of the vehicle.

FIG. 5 is a diagram showing an example of details of the content data 342 for each vehicle. In the content data 342 for each vehicle, content data is associated with a keyword and a vehicle ID. One or more pieces of content are stored in content data. Each piece of content includes an object associated with a shape based on the vehicle type of the vehicle 200, and information about a display position, a display size, a color and the like for each object. The provider 330 transmits the content acquired from the content data 342 for each vehicle to the vehicle 200 which has transmitted the content acquisition request.

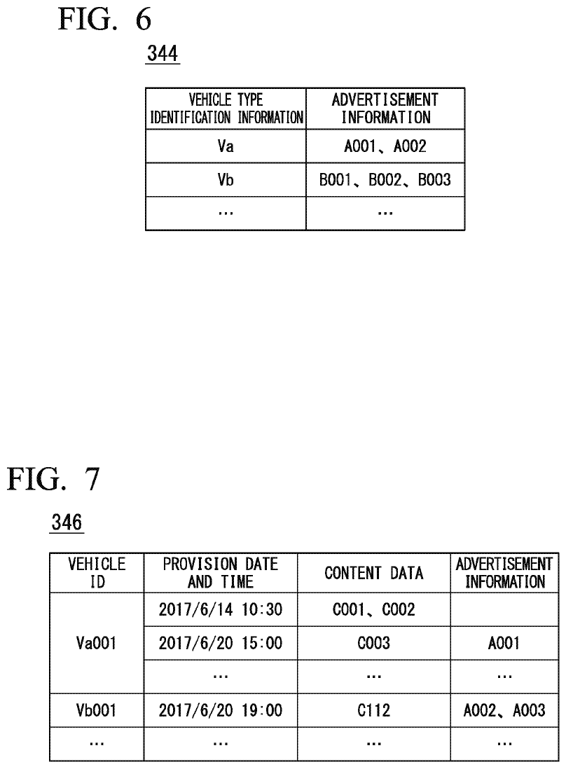

The provider 330 acquires advertisement information associated with a vehicle type with reference to the advertisement information 344 for each vehicle type on the basis of vehicle type information included in the vehicle identification ID of the content acquisition request. FIG. 6 is a diagram showing an example of details of the advertisement information 344 for each vehicle type. In the advertisement information 344 for each vehicle type, one or more pieces of advertisement information are associated with vehicle type identification information. Advertisement information includes information about a product or a service desired to be advertised and information about a display position, a display size, a color and the like of advertisement information in accordance with a vehicle type. The provider 330 transmits the acquired advertisement information to the vehicle 200 which has transmitted the content acquisition request. The provider 330 may receive a content acquisition request from the vehicle 200 in advance, refer to the content data 342 for each vehicle and the advertisement information 344 for each vehicle type at predetermined intervals, and when new content or advertisement information is provided, transmit the new content or advertisement information to the vehicle 200.

The provider 330 stores a provision history of content and advertisement information in the storage 340 as the user information 346. FIG. 7 is a diagram showing an example of details of the user information 346. In the user information 346, a provision date and time when one or both of content data and advertisement information has been provided to the vehicle 200, the provided content data and advertisement information are associated with a vehicle ID. When charging is performed for provision of content or a point is given for utilization of advertisement information, information about the aforementioned charging or point may be associated with a vehicle ID in the user information 346.

For example, when the provider 330 provides content to the vehicle 200, the provider 330 may acquire the number of times of utilization of content and advertisement information (the number of times of provisions of content) with reference to the user information 346 and provide rare content to the vehicle 200 when the acquired number of times of utilization is equal to or greater than a threshold value. The provider 330 may provide rare content to the vehicle 200 when a charged amount or a point is equal to or greater than a threshold value or there is a content acquisition request in a predetermined event execution period.

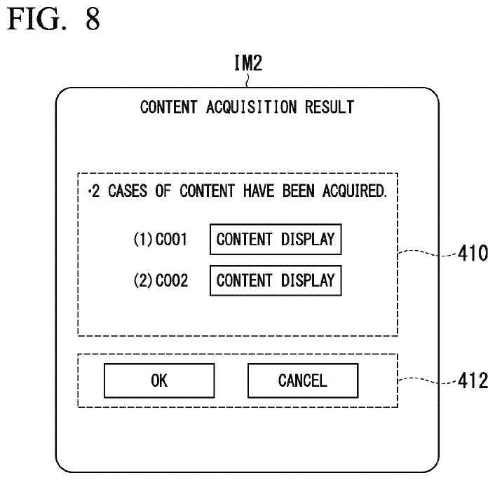

The acquirer 276 of the vehicle 200 displays an acquisition result of content acquired according to a content acquisition request of the requester 274 on the display of the HMI 232. FIG. 8 is a diagram showing an example of a content acquisition result screen IM2. The content acquisition result screen IM2 displays a content list area 410 in which a list of acquired content is displayed, and a determination operation area 412 through which confirmation or cancellation of a content acquisition result is determined.

Content display buttons through which details of acquired content are displayed are displayed in the content list area 410, and an occupant presses a content display button to display details of content on the display of the HMI 232. The occupant selects an OK button of the determination operation area 412. Accordingly, the acquirer 276 stores the acquired content in the content DB 278B. The occupant may select one or more pieces of content from content results displayed in the content list area 410 of the content acquisition screen IM2. In this case, the acquirer 276 stores the content selected by the occupant in the content DB 278B.

When the acquirer 276 acquires advertisement information from the content providing server 300, the acquirer 276 stores the acquired advertisement information in the advertisement information DB 278C. In this case, the acquirer 276 may display an advertisement information acquisition result screen like the content acquisition result screen IM2, or the like on the display of the HMI 232 and allow the occupant to select advertisement information.

### [Display Control of Content and Advertisement Information]

Next, an example of display control of content and advertisement information in an embodiment will be described. The display controller 270 refers to the display conditions data 278A stored in the storage 278 and controls display of content and advertisement information through the outside display 272.

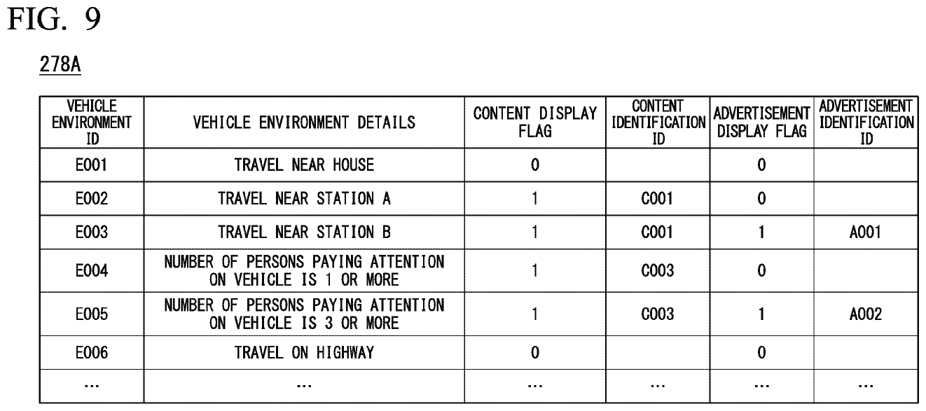

FIG. 9 is a diagram showing an example of details of the display conditions data 278A. In the display conditions data 278A, vehicle environment details representing specific details of a vehicle environment, a content display flag indicating whether content display is being performed, a content identification ID, an advertisement display flag indicating whether advertisement display is being performed, and an advertisement identification ID are associated with a vehicle environment ID for identifying the vehicle environment. In the example of FIG. 9, the content display flag is set to “1” when content is displayed and set to “0” when content is not displayed. The advertisement display flag is set to “1” when advertisement information is displayed and set to “0” when advertisement information is not displayed. Information set as a flag is not limited to “0 and 1” and may be information capable of indicating whether display is being performed, such as “YES and NO” and “a and b.” The display conditions data 278A may be provided by the content providing server 300 or set by an occupant.

The display controller 270 acquires environment information of the vehicle 200 on the basis of an environment of the surroundings or the vehicle cabin of the vehicle 200 provided by the outside monitoring unit 210 and the in-vehicle monitoring unit 245, and states such as steering, an acceleration/deceleration, a travel position and a travel road of the vehicle 200 provided by the automated driving control unit 250. The display controller 270 refers to the display conditions data 278A depending on the acquired environment information and acquires a content display flag and an advertisement display flag associated with environment information details matching the acquired environment information.

When the content display flag is “1,” the display controller 270 acquires content associated with a content identification ID from the content DB 278B and displays the acquired content on the outside display 272.

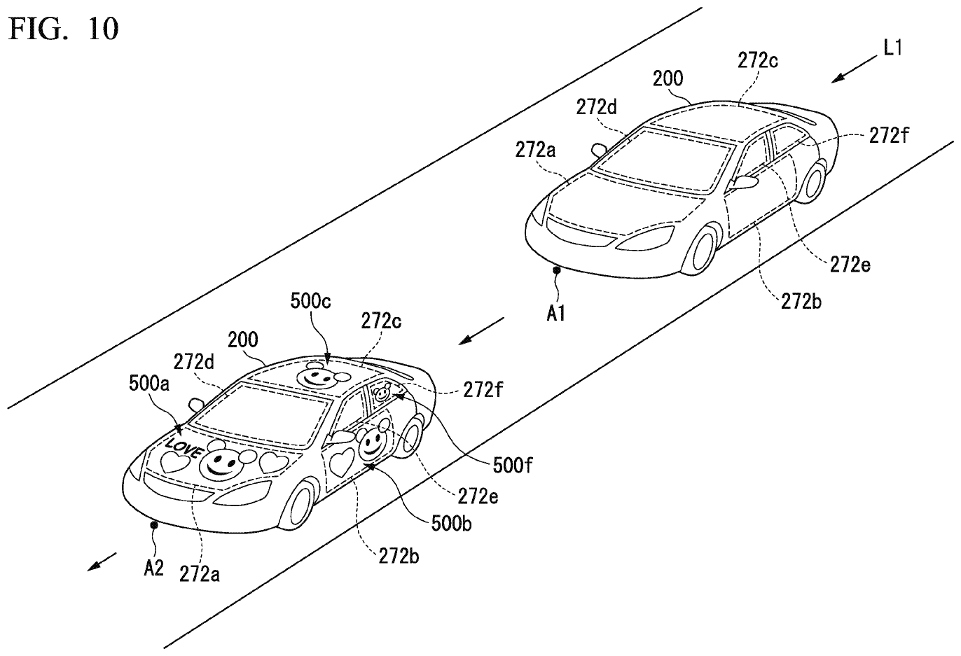

FIG. 10 is a diagram for describing a state in which content is displayed on the outside display 272. The vehicle 200 includes the outside display 272 provided on the front, rear, left, right and upper (roof part) parts of the vehicle. The example of FIG. 10 shows the vehicle 200 in which outside displays 272a to 272c are provided on the body part and outside displays 272d to 272f are provided on the windshield parts.

Next, display control of content and advertisement information based on the display conditions data 278A will be described in detail. For example, the display controller 270 may acquire positional information of the vehicle 200 from the automated driving control unit 250 and determine whether the position of the vehicle 200 is in proximity to a preset house of an occupant. Proximity to a house is within a range of a radius of tens of meters to hundreds of meters from the position of a house registered in advance. The same applies to “proximity to ∘∘” in the description below.

When the position of the vehicle 200 is in proximity to the house, the display controller 270 controls the outside display 272 such that content and advertisement information are not displayed on the outside display 272. In the example of FIG. 10, a point A of the vehicle 200 traveling in a lane L1 is assumed to be in proximity to the house. In this case, the display controller 270 does not display content and advertisement information on the outside display 272.

The display controller 270 acquires positional information of the vehicle 200 from the automated driving control unit 250 and determines whether the position of the vehicle 200 is in proximity to a station A. Positional information of the station A is acquired, for example, from map information of the navigation control device 236. When the position of the vehicle 200 is in proximity to the station A, the display controller 270 refers to the display conditions data 278A, acquires content having a content identification ID of “C001” from the content DB 278B and displays the content on the outside display 272. In the example of FIG. 10, a travel point A2 of the vehicle 200 is assumed to be in proximity to the station A. In this case, the display controller 270 displays content 500a to 500c and 500f associated with the outside displays 272a to 272c and 272f. Since this content is acquired on the basis of the vehicle identification ID, the display controller 270 can display objects in accordance with the size and shape of the vehicle 200.

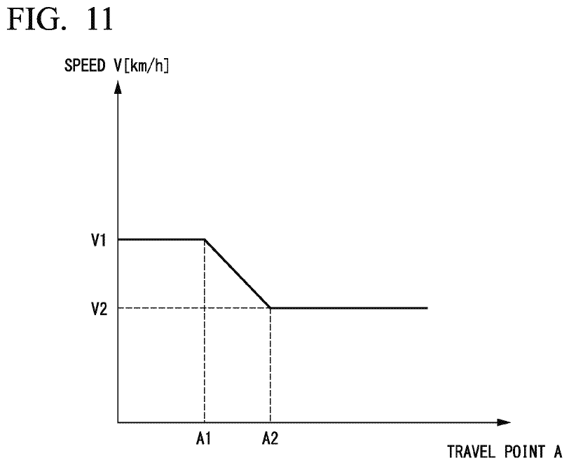

Here, the automated driving control unit 250 may control the speed of the vehicle 200 in connection with displaying of content 500 through the display controller 270. FIG. 11 is a diagram for describing speed control of the vehicle 200. The vertical axis of FIG. 11 represents a travel point A based on a predetermined route and the vertical axis represents a vehicle speed V [km/h]. The automated driving control unit 250 causes the vehicle 200 to travel at a speed V1 [km/h] when the vehicle 200 is traveling at a point A1 at which the content 500 is not displayed on the outside display 272. The automated driving control unit 250 performs deceleration control when the vehicle 200 comes into proximity to a point A2 at which content is displayed on the outside display 272 and causes the vehicle 200 to travel at a speed V2 (V2<V1) [km/h] when the vehicle 200 passes through the point A2. The speed V2 is set on the basis of a legal speed limit of the road on which the vehicle 200 is traveling and states of neighboring vehicles. Accordingly, content can be easily seen by persons around the vehicle 200 and thus can attract attention more efficiently.

The display controller 270 acquires positional information of the vehicle 200 from the automated driving control unit 250 and determines whether the position of the vehicle 200 is in proximity to a station B. Positional information of the station B is acquired, for example, from map information of the navigation control device 236. When the position of the vehicle 200 is in proximity to the station B, the display controller 270 refers to the display conditions data 278A, displays content having a content identification ID of “C001” on the outside display 272, acquires advertisement information having an advertisement identification ID of “A001” from the advertisement information DB 278C and displays the advertisement information on the outside display 272.

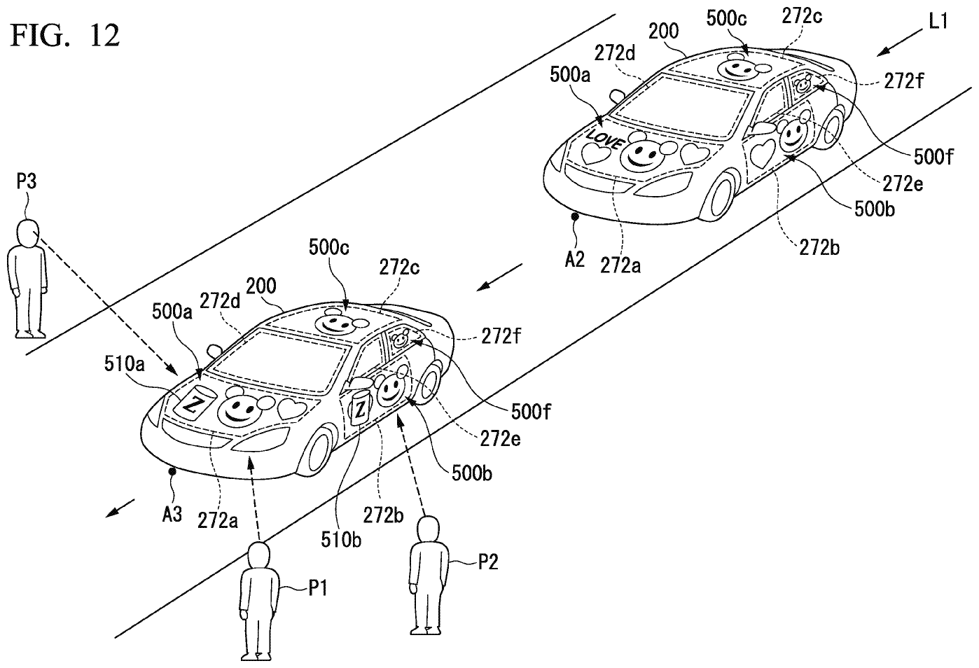

FIG. 12 is a diagram for describing display control of advertisement information. The example of FIG. 12 shows the vehicle 200 after passing through the travel point A2 shown in FIG. 10. In the example of FIG. 12, a travel point A3 of the vehicle 200 is assumed to be in proximity to the station B. In this case, the display controller 270 displays content 500a to 500c and 500f associated with the outside displays 272a to 272c and 272f and displays advertisement information objects 510a and 510b on the outside displays 272a and 272b.

When the display controller 270 displays advertisement information 510, the display controller 270 is configured to change some objects of content 500 to objects of the advertisement information and displays the advertisement information. The display controller 270 may display objects of the advertisement information 510 superposed on objects of the content 500. The display controller 270 may change display of the content 500 to display of only the advertisement information 510 and display the advertisement information 510.

The display controller 270 may display a product (e.g., canned coffee Z) that is an example of an object of the advertisement information 510 by adjusting the position, size, direction and the like of the object such that a character that is an object of the content 500 is holding or using the product. The display controller 270 may generate an image by combining the content 500 and the advertisement information 510 and display the generated image on the outside display 272.

In the example of FIG. 12, line-of-sight directions of persons P1 to P3 face the side of the vehicle 200 in proximity to the travel point A3 of the vehicle 200. In this case, the outside monitoring unit 210 detects the line-of-sight directions of the persons P1 to P3, sets a degree of attention on the vehicle 200 to “2” and outputs the degree of attention to the display controller 270. The display controller 270 displays the content 500 and the advertisement information 510 on the outside display 272 because the degree of attention exceeds a predetermined value (e.g., “1”). Accordingly, the vehicle 200 displays the advertisement information 510 after attracting attention of surrounding people by displaying the content 500 and thus can improve advertising effects of the advertisement information.

The display controller 270 may change display positions of objects included in the content 500 and the advertisement information 510 displayed on the outside display 272 depending on a line-of-sight direction of a person P obtained by the outside monitoring unit 210. For example, when the vehicle 200 passes through the position of the person P2 shown in FIG. 12, the display controller 270 may change display such that an object of a character included in the content 500 or an object of the advertisement information 510 is displayed in the line-of-sight direction of the person P2 in accordance with the line-of-sight direction of the person P2. Accordingly, the vehicle 200 can show the character and the object of the advertisement information 510 displayed on the outside display 272 to surrounding people for a long time.

The display controller 270 may control display of the content 500 and the advertisement information 510 depending on a travel state of the vehicle 200 obtained by the automated driving control unit 250. For example, when the vehicle 200 is traveling on a highway according to the automated driving control unit 250, the display controller 270 may control the content 500 and the advertisement information 510 such that they are not displayed. Accordingly, the vehicle 200 does not display the content 500 and the advertisement information 510 when there is no person therearound on a highway, and the like and thus can reduce power costs and the like for display. The display controller 270 may change an image of a character included in the content 500 to a running image and display the running image when the vehicle 200 is traveling at a speed equal to or higher than a predetermined speed (e.g., 60 [km/h]) and change the image of the character to an image in which the character stops and display the image when the vehicle 200 decelerates. Accordingly, the vehicle 200 can display content associated with a behavior of the vehicle.

The display controller 270 may control display of the content 500 and the advertisement information 510 depending on a state of an occupant detected by the in-vehicle monitoring unit 245. For example, when the in-vehicle monitoring unit 245 determines that the occupant is sleeping, the display controller 270 may control the content 500 and the advertisement information 510 such that they are not displayed. Accordingly, the vehicle 200 can reduce power costs and the like for display. When the vehicle 200 is a ridesharing vehicle and the number of occupants detected by the in-vehicle monitoring unit 245 is less than a predetermined number (e.g., 2), the display controller 270 may control the content 500 and the advertisement information such that they are displayed in order to attract attention of surrounding people. A ridesharing vehicle is one or more vehicles shared by a plurality of users.

The display controller 270 may perform vehicle-to-vehicle communication with a neighboring vehicle 200 and display content relative to content displayed on another neighboring vehicle. Content relative to content is, for example, content including objects having unity in type, color and shape, content related to each member in an idol group or an animation, and ideologically relative content such as stories. In the case of platooning of a plurality of vehicles, the display controller 270 may change the order of content displayed through the respective vehicles and display the content in the order in platooning. Accordingly, even when the order of a plurality of vehicles in platooning has changed, for example, content display order is changed depending on the order in platooning and thus details of an entire display in platooning can be uniform.

### [Processing Flow]

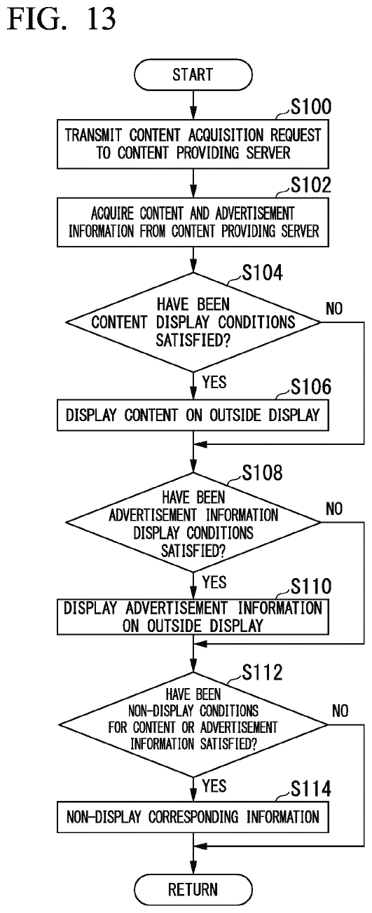

FIG. 13 is a flowchart showing an example of a processing flow executed by the vehicle 200. First, the requester 274 transmits a content acquisition request to the content providing server 300 (step S100). Next, the acquirer 276 acquires content and advertisement information from the content providing server 300 (step S102). Then, the display controller 270 determines whether display conditions for the content are satisfied with reference to the display conditions data 278A (step S104). When the display conditions for the content are satisfied, the display controller 270 displays the corresponding content on the outside display 272 (step S106).

Next, the display controller 270 determines whether display conditions for the advertisement information are satisfied with reference to the display conditions data 278A (step S108). When the display conditions for the advertisement information are satisfied, the display controller 270 displays the corresponding advertisement information on the outside display 272 (step S110).

Next, the display controller 270 determines whether non-display conditions for one or both of the content and the advertisement information are satisfied with reference to the display conditions data 278A (step S112). When the non-display conditions for the content or the advertisement information are satisfied, the display controller 270 does not display information of one or both of the corresponding content and advertisement information (step S114). Accordingly, processing of this flowchart ends. Processing of steps S100 and S102 may be performed asynchronously to processing of steps S104 to S114.

As described above, according to the first embodiment, it is possible to realize content display to the outside of a vehicle in a state suitable for the environment of the vehicle.

### Second Embodiment

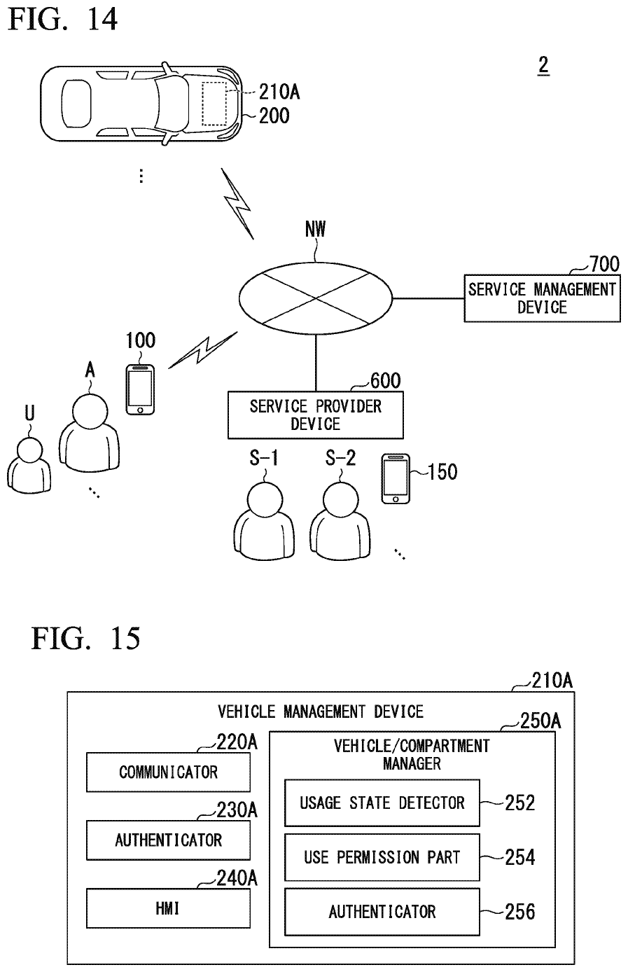

Hereinafter, a second embodiment will be described. FIG. 14 is a configuration diagram of a service providing system 2 including a vehicle 200 according to the second embodiment. The service providing system 2 includes one or more terminal devices 100 used by one or more service applicants A, one or more vehicles 200, one or more terminal devices 150 used by one or more service providers S, a service provider device 600, and a service management device 700. These components can communicate with one another through a network NW. Services from the service providers S are provided to service users U. Although the figure shows the service applicant A and the service user U are different persons, they may be the same person. “Using by the service applicant A” may include “temporarily using a terminal device that can be used by unspecified individuals, such as a terminal device of an Internet café, by the service applicant A.”

### [Terminal Device]

The terminal device 100 is, for example, a smartphone, a tablet terminal, a personal computer or the like. The terminal device 100 supports services described below by starting an application program or a browser for using the service providing system 2. The following description is based upon the premise that the terminal device 100 is a smartphone and the application program (application for service applicants) has been started. An application for service users communicates with the service management device 700 according to an operation of the service applicant A and transmits a request from the service applicant A to the service management device 700 or performs a push notification based on information received from the service management device 700.

The terminal device 100 transmits, for example, service use request information including details described below to the service management device 700. Positional information may be identified by a GPS receiver included in the terminal device 100, for example. Other types of information are based on information input by the service applicant A or the service user U in principle. Desired service provider attribute information is information about attributes of the service provider S desired to be used by the service user U. Attributes may include an age, a sex, a character (type) and the like in addition to the type of a service to be provided. With respect to attributes, the service management device 700 may suggest service providers S to the service user U and allow the service user U to select or determine a perfectly matching service user U instead of performing fixed allocation of a perfectly matching service provider S.

### [Service Use Request Information]

User ID
Positional information (latitude, longitude and altitude)
Desired space information (represented by the number of persons, the number of seats, or the like, for example)
Desired service provider attribute information
Desired service ID
Desired section information (information on first section)
Information on time period for use of service desired by service user
Settlement authentication information

### [Vehicle]

Components relative to travel control of the vehicle 200 (e.g., components relative to automated driving) are the same as those included in the vehicle 200 in the first embodiment. That is, the vehicle 200 is an automated driving vehicle and a vehicle having a wireless communication function as described below. FIG. 15 is a diagram showing an example of a configuration of a vehicle management device 210A mounted in the vehicle 200. The vehicle management device 210A includes, for example, a communicator 220A, an authenticator 230A, an HMI 240A, and a vehicle/compartment manager 250A.

The communicator 220A is a wireless communication device. The communicator 220A communicates with the service management device 700 through the network NW. The authenticator 230A performs authentication processing for starting a service according to an instruction of the service management device 700. The HMI 240A is, for example, a touch panel type display device (displayer), a speaker, a microphone, or various operation switches or the like provided separately from the HMI 232.

The vehicle/compartment manager 250A includes, for example, a usage state detector 252, a use permission part 254, and an authenticator 256. One or more spaces (compartments) that can be used by the service user U and the service provider S are provided in the vehicle 200. A compartment is, for example, a seat, a loading area in which cargo is loaded, or the like. For example, a compartment may be an area, for example, defined by a predetermined partition. For example, a compartment controller which is not shown may convert a seat to a loading area or convert a loading area to a seat by controlling a mechanism for driving seats and loading areas. Further, the compartment controller may store a seat in a storage part for storing the seat or take the seat stored in the storage part out of the storage part. The usage state detector 252 detects a usage state of each compartment. For example, the usage state detector 252 may detect whether each compartment is being used. Although a normal car is shown as the vehicle 200 in FIG. 14, the vehicle 200 may be a vehicle with a size such that one or more occupants can ride in respective compartments partitioned from a vehicle cabin, such as a trailer, a bus, a microbus, or the like. The use permission part 254 permits use of compartments designated in advance and performs, for example, door unlocking and the like when authentication has been successfully performed by the authenticator 256, for example. The authenticator 256 performs authentication such as personal identification of the service user U or the service provider S who will ride in a vehicle.

The vehicle management device 210A transmits, for example, vehicle information including details described below to the service management device 700.

### [Vehicle Information]

Vehicle ID
Positional information (latitude, altitude and longitude)
Compartment usage state (a user ID of a service user who is using a compartment that is being used, information on available compartments, and the like)
Travel state (speed, acceleration, angular velocity, an on-board apparatus state, and the like)
Information on service provider S (service provider ID, information on a service being executed, an elapsed time after executing the service, and the like)
Display content ID (content ID displayed on the outside display 272), display destination ID (ID indicating a position of content displayed on the outside display 272 in the outside display 272)

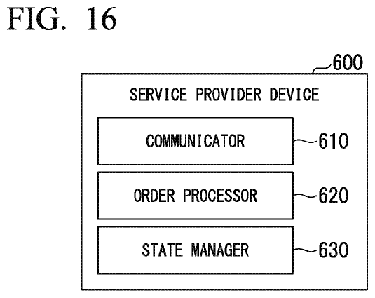

FIG. 16 is a diagram showing an example of a configuration of the service provider device 600. The service provider device 600 is, for example, a device which detects states of a plurality of service providers and can automatically respond to an order from the service management device 700. The service provider device 600 includes, for example, a communicator 610, an order processor 620, a state manager 630, and a storage 650. The service provider device 600 may include the functional configuration of the content providing server 300.

The communicator 610 communicates with the service management device 700 or the like through the network NW. The order processor 620 performs order reception processing for a service order from the service management device 700. The order processor 620 determines whether details of the service order are within a range of service provision information that has already been transmitted to the service management device 700 and proceeds with the order reception processing when it is determined that the details of the service order are within the range. The state manager 630 manages states (reservation states, operation states, and the like) of service providers S registered in the service provider device 600 and provides service provision information to the service management device 700.

The service provider device 600 transmits, for example, service provision information including details described below to the service management device 700. The service provision information is information about services that can be ordered from a service provider S.

### [Service Provision Information]

Order reception ID
Service name
Information on person responsible for execution
Service provider attribute information
Information on service provision time period desired by service provider
Necessary vehicle compartment information
Information on area in which service can be provided
Facility point information (information on a service provision site outside a vehicle)
Information about content ID (e.g., information on available content)
Service status

In addition, when there is a content provision request from the service management device 700, the service provider device 600 transmits content associated with the request to the service management device 700. In this case, various types of content associated with content IDs are stored in a storage device of the service provider device 600. Various types of content may be stored in advance in a storage device of the service management device 700. The terminal device 150 is, for example, a smartphone, a tablet terminal, a personal computer, or the like. The terminal device 150 supports services described below by starting an application program or a browser for using the service providing system 2. The terminal device 150 transmits the same information as service use request information to the service management device 700. That is, the terminal device 150 has the same function as that of the terminal device 100.

### [Service Management Device]

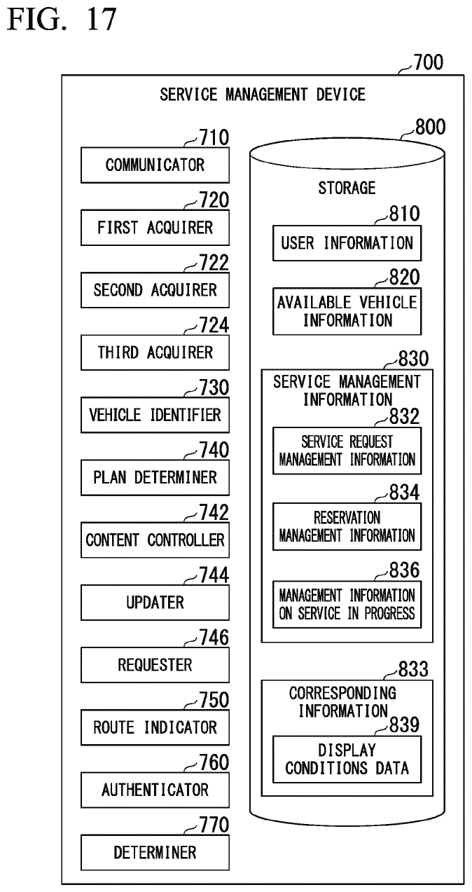

FIG. 17 is a diagram showing an example of a configuration of the service management device 700. The service management device 700 includes, for example, a communicator 710, a first acquirer 720, a second acquirer 722, a third acquirer 724, a vehicle identifier 730, a plan determiner 740, a content controller 742, an updater 744, a requester 746, a route indicator 750, an authenticator 760, a determiner 770, and a storage 800. Components other than the communicator 710 and the storage 800 are realized, for example, by a hardware processor such as a CPU executing a program (software). Some or all of these components may be realized by hardware (circuit part including a circuitry) such as an LSI circuit, an ASIC, an FPGA and a GPU or realized by software and hardware in cooperation. The program may be stored in advance in a storage device such as an HDD, a flash memory or the like, or stored in a detachable storage medium such as a DVD or a CD-ROM and installed in a storage device when the storage medium is inserted into a drive device. The storage 800 is realized by an HDD, a flash memory, a RAM, a ROM or the like.

The communicator 710 is, for example, a network card for accessing the network NW. The communicator 710 communicates with the terminal device 100, the terminal device 150, the vehicle management device 210A, the service provider device 600 and the like through the network NW.

The first acquirer 720 acquires service use request information from the terminal device 100 and the terminal device 150 through the communicator 710. The second acquirer 722 acquires vehicle information or environment information from the vehicle management device 210A of a vehicle 200 registered in advance through the communicator 710. The third acquirer 724 acquires service provision information from the service provider device 600 through the communicator 710.

The vehicle identifier 730 identifies an available vehicle 200 on the basis of service use request information and vehicle information and generates available vehicle information 820. Specifically, the vehicle identifier 730 compares desired space information, desired section information and service use time period information included in the service use request information with positional information and a compartment usage state included in the vehicle information and identifies a vehicle whose positional information and compartment usage state satisfies conditions included in the service use request information as an available vehicle 200.

The plan determiner 740 identifies an available service that the service user U can enjoy on the basis of the available vehicle information 820 and the service provision information and provides information about the identified available service to the terminal device 100 of the service user U.

More specifically, the plan determiner 740 sets a second section in which the service provider S occupies at least a part (e.g., a compartment) of the vehicle 200 on the basis of the available vehicle information 820 and the service provision information and sets a third section in which the service user U and the service provider S occupy at least a part of the vehicle 200 on the basis of an overlap part of the desired section information (information on a first section) in the service use request information and the second section. When the service provider S has already boarded the vehicle 200 before the first section is set, the plan determiner 740 may set the second section having the current position of the vehicle 200 as a starting point simultaneously with setting of the first section.

In addition, the plan determiner 740 sets the third section within an overlap range of information on an area in which the service can be provided included in the service provision information and the first section. Further, the plan determiner 740 sets the third section such that a time period in which the service user U occupies at least a part of the vehicle 200 matches information on a service use time period desired by the service user U and a time period in which the service provider S occupies the vehicle matches information on a service provision time period desired by the service provider S. A “time period” includes time such as start time and end time and a duration. When the service use time period desired by the service user U is not included within the service provision time period desired by the service provider S, for example, the plan determiner 740 may limit the time period in which the service user U occupies at least a part of the vehicle 200 such that it is shorter than the service user time period desired by the service user U to adjust the service use time such that it is included within the service provision time period. On the contrary, when the service provision time period desired by the service provider S is not included within the service use time period desired by the service user U, for example, the plan determiner 740 may limit the time period in which the service provider S occupies at least a part of the vehicle 200 such that it is shorter than the service provision time period desired by the service provider S to adjust the service provision time period such that it is included within the service user time period. Then, the plan determiner 740 identifies an available service on the basis of the set third section.

Further, when a plurality of service providers S sequentially provide services to a certain service user U, the plan determiner 740 may set second sections associated with the respective service providers S and set third sections associated with the respective second sections.

As another function, the plan determiner 740 may update the first section such that the first section ends at a service provision point outside the vehicle according to an instruction from the service user U using the terminal device 100. In this case, the plan determiner 740 may transmit reservation information with respect to a facility present at the service provision point outside the vehicle using the communicator 710 according to an instruction from the service user U (or automatically) using the terminal device 100, receive a reservation result through the communicator 710 and transmit the reservation result to the terminal device 100 of the service user U using the communicator 710.

Further, the plan determiner 740 refers to a corresponding relationship between a user of the vehicle during travel of the vehicle or an operator of the vehicle and content (a corresponding relationship included in corresponding information 838 described later). The operator of the vehicle is a person who arranges operation of the vehicle, a person responsible for operation or an owner of the vehicle. For example, the operator of the vehicle may be a service manager, a service provider or the like in an embodiment.

The content controller 742 performs processing of displaying content on the outside display 272. The content controller 742 permits use of content on the basis of a reference result of the plan determiner 740. Functions of the updater 744 will be described in detail later. The requester 746 causes the communicator 710 to transmit a content request for requesting content to the service provider device 600.

The route indicator 750 indicates, to the vehicle 200, a route along which the vehicle 200 will travel by causing the communicator 710 to transmit information on a user start position and a user end position of the service user U and a user start position and a user end position of the service provider S to the vehicle 200.

The authenticator 760 performs authentication of the service user U according to communication with the terminal device 100 and the terminal device 150 or performs authentication when service provision is started.

The determiner 770 determines whether each of the service user U and the service provider S is using the vehicle 200.

The plan determiner 740 performs various types of processing using a determination result of the determiner 770. For example, the plan determiner 740 may accept change of the first section (update the first section) only when the determiner 770 determines that both the service user U and the service provider S are using the vehicle 200. This case occurs, for example, when the service provider S suggests change of a destination to the service user U or changes a final destination during service on the basis of information provided to the side of the vehicle 200. In addition, when the determiner 770 determines that the service user U has already been using the vehicle 200 (i.e., when service extension or a request for a separate service has been performed) at a time when the first acquirer 720 receives service use request information, the plan determiner 740 may preferentially allocate the vehicle 200 that is being used to the service user U.

The storage 800 stores user information 810 about a registered service user U, the aforementioned available vehicle information 820, service management information 830 and the corresponding information 838. The service management information 830 includes, for example, service request management information 832, reservation management information 834, and management information on a service in progress 836. Each piece of service use request information acquired by the first acquirer 720 is registered as a record in the service request management information 832. Information such as a reservation use section, a reservation use time period, a stop and an estimated arrival time at a stop is stored in the reservation management information 834 for each service. Information such as a service status, service attributes, and a service provider ID is registered in the management information on a service in progress 836. The corresponding information 838 is information transmitted from the terminal device 100, the terminal device 150 or the vehicle management device 210A and information in which a user ID (or a driver ID of a driver who drives the vehicle), a vehicle ID and a content ID requested to be used by a user are associated.

In the corresponding information 838, a content provider ID, a content user target area ID, a content use time, a content attention degree index, and the like are associated with a content ID. The content use target area ID is, for example, an ID indicating an area in which content can be used. The content use time is a time at which content can be used.

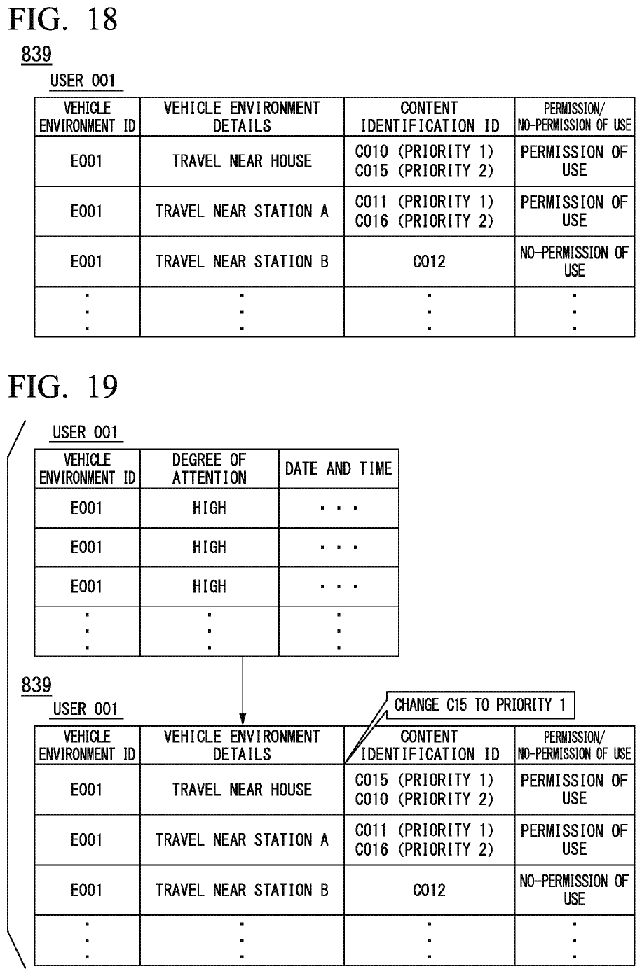

The corresponding information 838 includes display conditions data 839. For example, a vehicle environment ID, vehicle environment details, a content identification ID, and information indicating whether use is permitted are associated with each user (or operator) in the display conditions data 839, as shown in FIG. 18. The display conditions data 839 may include the same information as the display conditions data 278A, for example.

The updater 744 updates the corresponding information 838 of a vehicle user or a vehicle operator and content. For example, the updater 744 updates a corresponding relationship between a vehicle user or operator and content in the corresponding information 838. Updating includes recording or storage of results, change in priority of displayed content, and the like. Processing results and usage states of the vehicle management device 210A and the service provider device 600 which provides content are counted and thus a correlation between the content and an exposure degree, usage degree and environment information of the content, and the like can be ascertained. Then, the service management device 700 can derive a usage result of the content on the basis of a processing result of the updater 744 and provide a derivation result to the provider or a predetermined manager. The usage result is used, for example, for measurement of an incentive for the user or the content provision source.

For example, the updater 744 stores, in the storage 800 as corresponding information 838, information in which a vehicle environment ID, a degree of attention, and a date and time for each user are associated with one another, as shown in FIG. 19. Then, the updater 744 updates the display conditions data 839 on the basis of the corresponding information 838. For example, in the display conditions data 839, the updater 744 may set “content C10” having priority 1 before update to priority 2 after update and set “content C15” having priority 2 before update to priority 1 after update. That is, the updater 744 increases a priority of content having a high degree of attention.

The updater 744 may acquire, from the vehicle 200, information (an example of “environment information”) on the line of sight of a person around the vehicle 200 which is associated with content displayed on the outside display 272 and the position at which the content is displayed in the outside display 272, and update a corresponding relationship between the user of the vehicle 200 or the operator of the vehicle 200 and the content on the basis of the acquired information. For example, the updater 744 may reflect the position at which the content is displayed, the type of the content and a correlation between the content and the position in the display conditions data 839 to update the display conditions data 839 such that a frequency of the line of sight of the person facing the content increases or a time for which the line of sight faces the content increases.

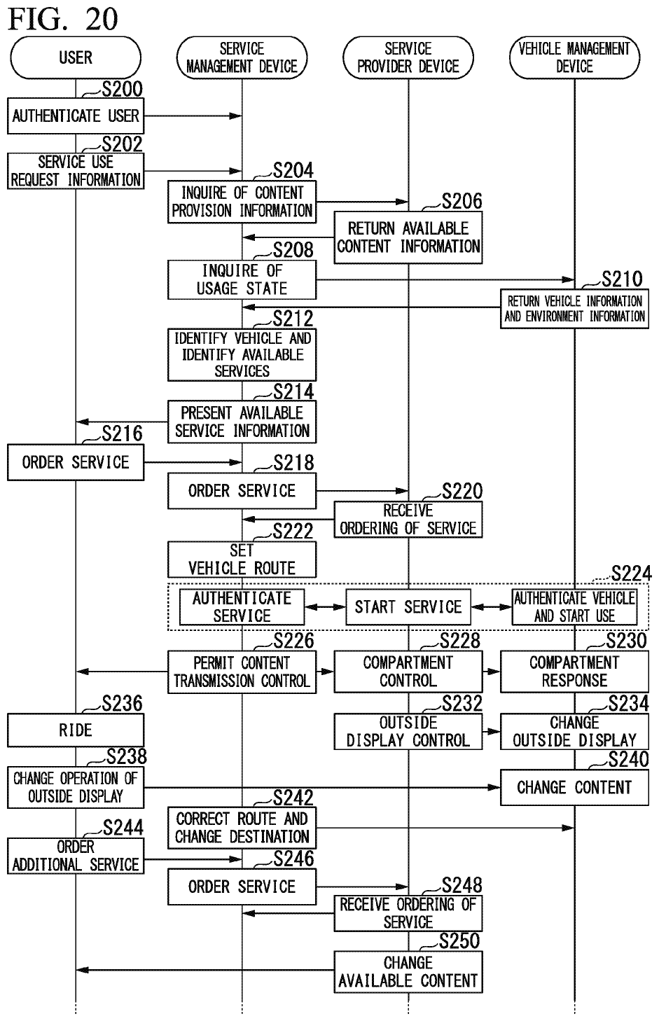

The updater 744 may update a corresponding relationship between content acquired from the service provider device 600 and a user of the vehicle 200 or an operator of the vehicle when the vehicle 200 is traveling according to the request of the requester 746 (refer to FIG. 20). For example, the updater 744 may associate a user who has requested content with an acquired content ID.

FIG. 20 is a flowchart showing an example of a processing flow executed in the service providing system 2. FIG. 20 shows an example of processing in which display of the outside display 272 of the vehicle 200 is changed according to a request from a service provider S (a user sharing the vehicle).

First, a service client A (service provider S) performs user authentication for the authenticator 760 of the service management device 700 using the terminal device 150 (step S200). When authentication by the authenticator 760 has been successfully performed, the service client A (service provider S) transmits service use request information to the service management device 700 using the terminal device 150 (step S202). The service use request information is acquired by the first acquirer and stored in the storage 800 as service request management information 832. The service use request information in this flowchart is, for example, information for requesting use of content (hereinafter, content use request information).

When the content use request information is acquired, the third acquirer 724 of the service management device 700 inquires of the service provider device 600 about content provision information (step S204). A plurality of service provider devices 600 may be present depending on attributes and service providers of content (or services) to be provided. In this case, the third acquirer 724 may simultaneously inquire of the plurality of service provider devices 600. The state manager 630 of the service provider device 600 returns information related to available content (representing details of available content) to the service management device 700 (step S206). The state manager 630 returns information on provision of services that can be ordered to the service management device 700.

The second acquirer 722 of the service management device 700 inquires of the vehicle management device 210A of a usage state (vehicle information) (step S208). The vehicle/compartment manager 250A of the vehicle management device 210A returns, to the service management device 700, vehicle information and environment information detected by the usage state detector 252 along with a vehicle ID associated with the vehicle management device 210A (step S210). The environment information includes positional information of the vehicle 200 and information representing a surrounding state of the vehicle. The information representing a surrounding state of the vehicle is a degree of attention on the vehicle 200. Processing of steps S208 and S210 may be always performed at any timing asynchronously with processing shown in the flowchart.

Next, the vehicle identifier 730 identifies an available vehicle on the basis of the content use request information and the information acquired in step S210 and generates available vehicle information (step S212). A plurality of vehicles may be identified in step S212. In this case, identification of a final vehicle may be performed until step S224 described later. Then, the plan determiner 740 identifies an available service that can be enjoyed by the service provider S (e.g., an available service or content) on the basis of the available vehicle information and the available content information acquired in step S206 (step S212) and transmits available service information representing details of the identified available service to the terminal device 150 (step S214).

The service client A (service provider S) reads the available service information and performs service ordering (e.g., service ordering with respect to the content or service ordering with respect to use of the vehicle) for the service management device 700 using the terminal device 150 as a result (step S216). The plan determiner 740 of the service management device 700 extracts a part for which the service provider device 600 will be responsible from among services ordered in step S216 and performs service ordering for the service provider device 600 (step S218).

The order processor 620 of the service provider device 600 transmits the intent of service ordering to the service management device 700 (step S220). In addition, the order processor 620 transmits details of ordering reception to the terminal device 150 of the service provider S.

When the intent of ordering is received from the service provider device 600, the route indicator 750 of the service management device 700 sets a route along which the vehicle 200 will travel in order to provide the service (step S222).

Next, the authenticator 760 of the service management device 700 performs authentication processing for starting the service on the service provider device 600 and the authenticator 230A of the vehicle 200, the route indicator 750 indicates the route set in step S222 to the vehicle 200, the service provider device 600 performs authentication of starting of the service and performs final vehicle identification as necessary, and the authenticator 230A in the vehicle management device 210A of the vehicle 200 performs authentication on the side of the vehicle and starts or schedules travel along the indicated route (step S224).

Next, when a distance between the vehicle 200 and the service client A reaches a set distance, for example, the content controller 742 of the service management device 700 transmits requested content information along with the environment information of the vehicle 200 including the positional information to the terminal device 150 (step S226). Further, the content controller 742 transmits the content information and compartment information to the service provider device 600 (step S228). That is, the service management device 700 that is an operator associates the content information related to the service provider S with the environment information of the vehicle including the positional information and provides the associated information on the basis of the request from the service provider S as a user. The compartment information is, for example, information for controlling functions related to compartments. For example, the compartment information may be control information for changing a loading area to a seat and information for controlling each function of devices provided in other compartments, and the like.

Next, the service provider device 600 acquires the compartment information and transmits the acquired compartment information to the vehicle management device 210A (step S230). When the compartment information is acquired, the vehicle management device 210A performs predetermined control on the vehicle 200 in response to this information (step S230). Meanwhile, the terminal device 150 may directly communicate with the vehicle 200 to transmit the content information, the compartment information and the like to the vehicle 200.

Next, the service provider device 600 acquires the content information and transmits the acquired content information to the vehicle management device 210A (step S232). That is, the service provider device 600 performs control of displaying the content information on the outside display 272 of the vehicle 200 (outside display control). When the vehicle management device 210A acquires the content information, the display controller 270 of the vehicle 200 displays the content on the outside display 272 in response to this information (step S234). The display controller 270 changes display outside the vehicle.

Thereafter, the service client A rides in the vehicle 200 (step S236) and operates, for example, the HMI 240A to instruct outside display to be changed (step S238), and when the display controller 270 of the vehicle 200 acquires information about details of the operation, the display controller 270 changes content in response to the acquired operation (step S240). Although an example in which the service client A transmits the service use request information to the service management device 700 using the terminal device 150 and then rides in the vehicle 200 has been described in FIG. 20, the service client A may ride in the vehicle 200 and then transmit the service use request information to the service management device 700 by operating the terminal device 150 or the HMI 240. In addition, the HMI 240A may have the same function as that of the terminal device 150. In this case, the service client A can ride in the vehicle 200 and then instruct outside display to be changed by operating the HMI 240A instead of the terminal device 150, for example.

As described above, when the vehicle 200 has changed content, the vehicle 200 transmits information on the changed content to the service management device 700. When the service management device 700 acquires the information on the changed content, the route indicator 750 of the service management device 700 determines execution of correction of a route, change of a destination or change of a travel state, and the like on the basis of the information on the acquired content and transmits the determination result to the vehicle 200 (step S242). For example, when the acquired information on the content is first information, the route indicator 750 may determine travel along a route associated with the first information, determine travel toward a destination or change a travel state. Meanwhile, the route indicator 750 may determine execution of correction of a route, change of a destination, change of a travel state or the like on the basis of acquired environment information and transmit the determination result to the vehicle 200. For example, the route indicator 750 may determine change of routes to a route that attracts attention of people or determine travel with a reduced speed. In such a case, the vehicle 200 executes control based on the determination result. That is, the vehicle 200 travels along a corrected route, travels toward a changed destination or travels in a changed travel state.

When an additional service can be presented, the plan determiner 740 presents the additional service to the terminal device 150 (step S244). When the service client A reads details of the additional service and orders the additional service using the terminal device 150 (step S244), the plan determiner 740 of the service management device 700 performs service ordering with respect to the additional service for the service provider device 600 (step S246). The order processor 620 of the service provider device 600 transmits information representing the intent of additional service ordering to the service management device 700 (step S248). When the information representing the intent of additional service ordering is received, the route indicator 750 of the service management device 700 notifies the service client A of reception of change of available content (step S250).

The above-described processing is performed and the content requested by the service client A is displayed while the vehicle is traveling. Specifically, the plan determiner 740 refers to a corresponding relationship between a vehicle user (or operator) during travel of the vehicle recognized on the basis of the environment (environment information) of the vehicle and the content and the content controller 742 permits use of the content on the basis of the reference result and thus the content is displayed on the outside display 272.

The plan determiner 740 may acquire a state of an occupant from the vehicle 200 and determine whether to refer to the corresponding relationship between the content vehicle user or the vehicle operator and the content depending on the acquired state of the occupant. For example, the plan determiner 740 may determine that the content is not displayed on the outside display 272 without referring to the corresponding relationship when it is determined that the occupant is sleeping. In addition, the state of the occupant may be the attribute of the occupant such that whether the occupant is an adult, presence or absence of authentication or subscription of a charged service, an elapsed time from riding in the vehicle, or the like. For example, the plan determiner 740 may determine that the content is not displayed on the outside display 272 without referring to the corresponding relationship when the occupant is not an adult and when the occupant does not subscribe to a charged service.

The route indicator 750 may instruct a travel state or a route to be changed according to environment information acquired from the vehicle 200. For example, when the route indicator 750 acquires information indicating a low degree of attention from the vehicle 200, the route indicator 750 may instruct the vehicle 200 to travel along a route set or acquired in advance (a route attracting a high degree of attention) or instruct the vehicle 200 to travel in a travel state attracting a high degree of attention (a travel state in which a speed is reduced).

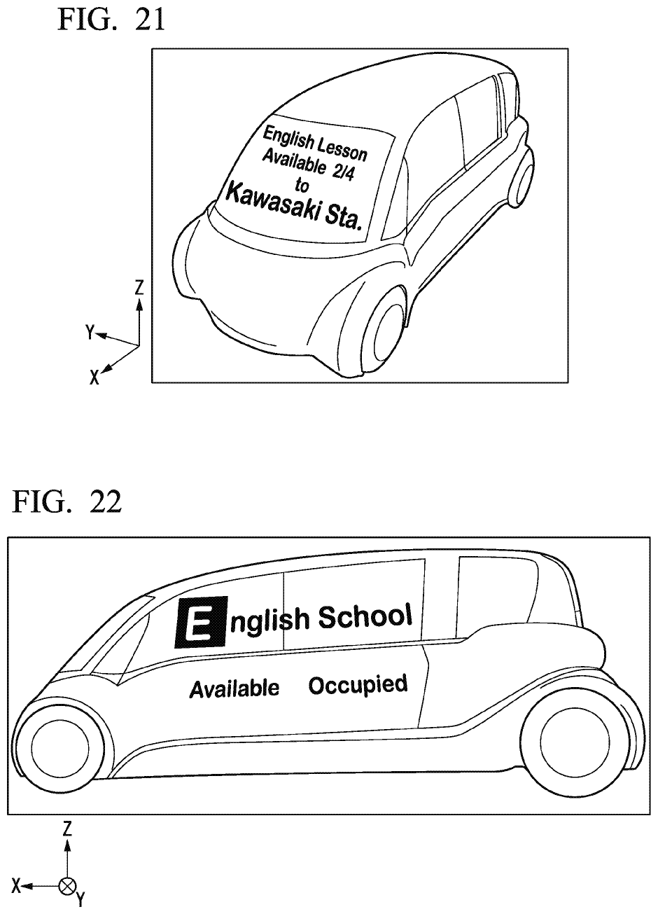

Hereinafter, information displayed on the outside display 272 of the vehicle 200 on the basis of control of the service management device 700 or the service provider device 600 will be described. A specific example when the service management device 700 refers to environment information and a corresponding relationship between a vehicle operator and content and causes the content to be used on the basis of a reference result will be described with reference to FIG. 21 to FIG. 30. This is an example in which content relative to a service provided by a service provider that is an operator is displayed on the outside display 272. Hereinafter, illustration and description will be performed using the XYZ coordinate system as necessary. X and Y directions are directions along approximately a horizontal plane. The X direction is a direction in which a vehicle progresses and the Y direction is a direction intersecting (e.g., approximately perpendicular to) the X direction. The Z direction is a direction intersecting (e.g., approximately perpendicular to) the X direction and the Y direction.

For example, a trademark or a logo indicating a service, details of the service (English conversation institution), a destination of the vehicle 200, a service provision state (information indicating whether the service can be used) and the like may be displayed on the outside display 272. FIG. 21 is a perspective view of the vehicle 200 providing a service with respect to an English conversation institution. FIG. 22 is a diagram of the vehicle 200 providing the service with respect to the English conversation institution, viewed in the lateral direction.

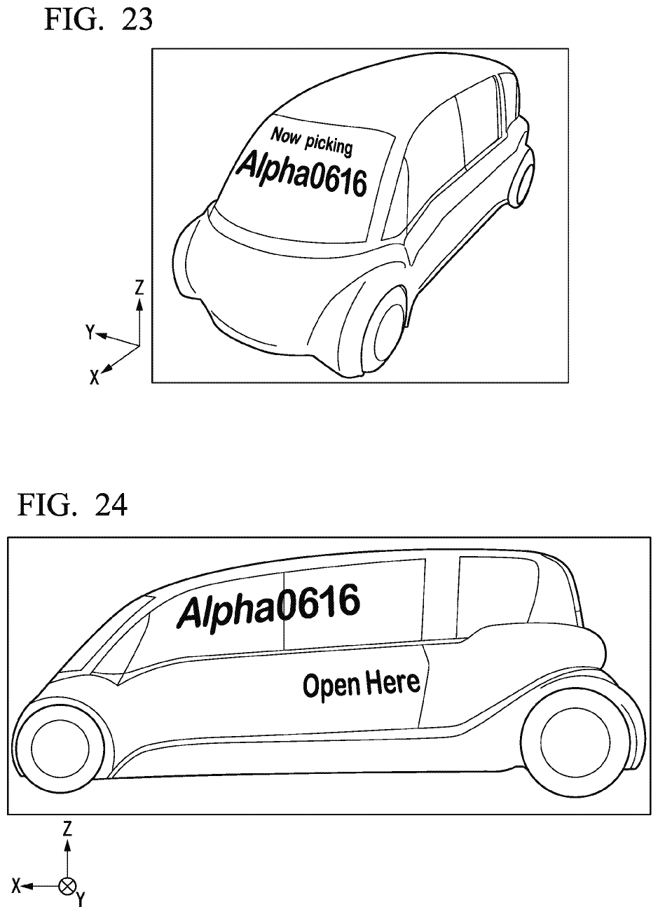

For example, information (e.g., a name, a nickname, a reservation number and the like) representing a user who has reserved use of the vehicle 200 (next user approaching the vehicle 200) is displayed on the outside display 272. FIG. 23 is a perspective view of the vehicle 200 having the outside display 272 on which information on the user who has reserved use of the vehicle is displayed. FIG. 24 is a diagram of the vehicle 200 having the outside display 272 on which information on the user who has reserved use of the vehicle is displayed, viewed in the lateral direction.

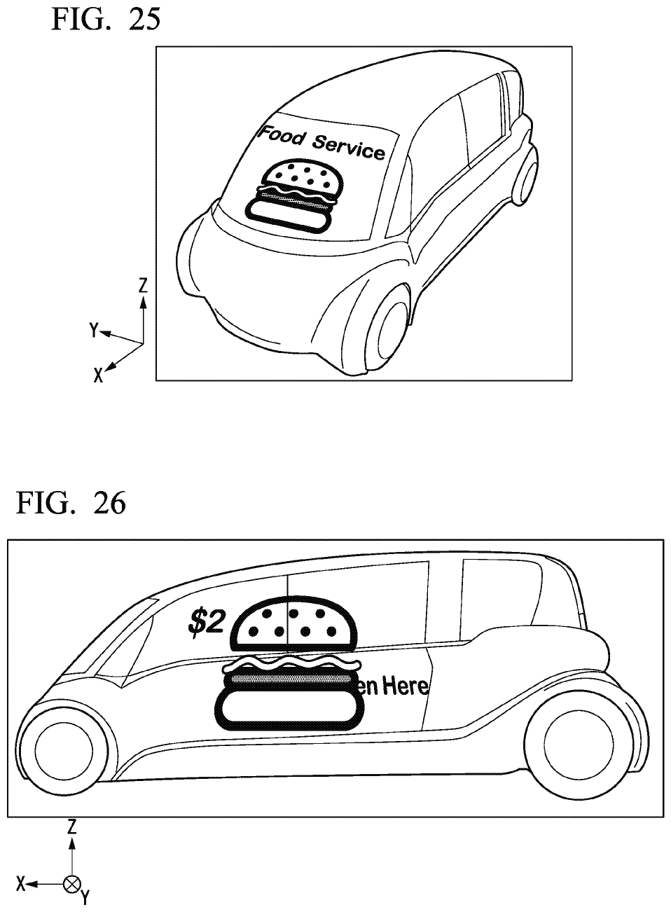

For example, information representing attributes (e.g., a product or food on sale, a provided service, and the like) of a service provided by the vehicle 200 or conditions for provision of a product or service (a price and a provision time) is displayed on the outside display 272. FIG. 25 is a perspective view of the vehicle 200 having the outside display 272 displaying an attribute of a service. FIG. 26 is a diagram of the vehicle 200 having the outside display 272 displaying information on the attribute of the service, viewed in the lateral direction.

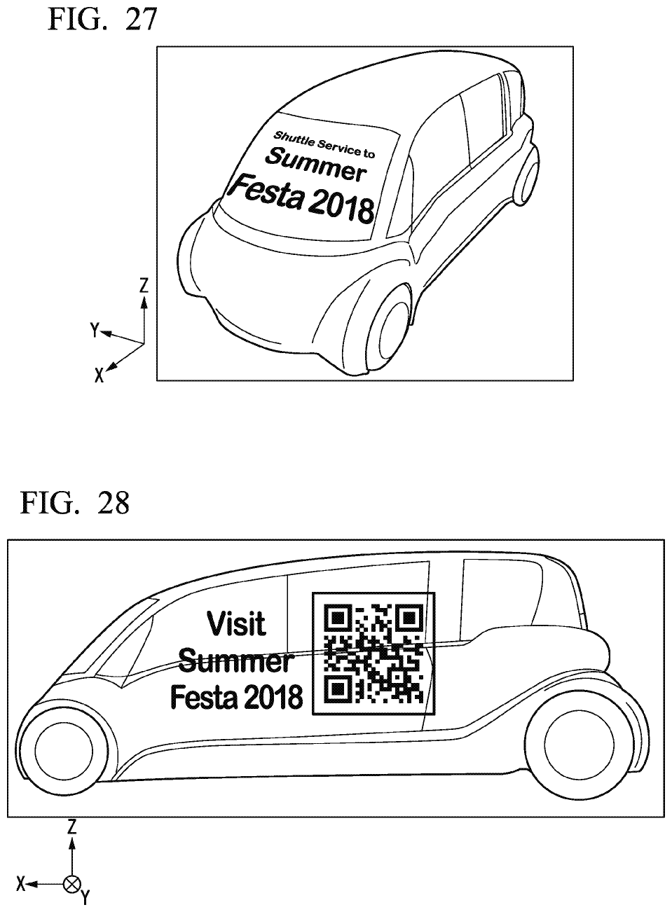

For example, information about an event (an event name and an event date) and information for accessing the information (a URL, a 2-dimensional barcode, or the like) are displayed on the outside display 272. FIG. 27 is a perspective view of the vehicle 200 having the outside display 272 displaying information about an event. FIG. 28 is a diagram of the vehicle 200 having the outside display 272 displaying the information about the event, viewed in the lateral direction. For example, the vehicle shown in FIG. 27 and FIG. 28 is a vehicle traveling toward an event venue and a user going to the vent can ride in the vehicle.

For example, information about an event (an event name and an event date) and information for accessing the event (a URL, a 2-dimensional barcode or the like) may be displayed on the outside display 272 provided on the rear side of the vehicle. FIG. 29 is a diagram of the vehicle viewed on the rear side. For example, the vehicle 200 on which the information about the event is displayed may travel toward the event venue. A user interested in the event can arrive at the event venue by following the vehicle 200. The user can follow the vehicle 200, when following the vehicle 200, while viewing the information about the event displayed on the rear side of the vehicle 200.

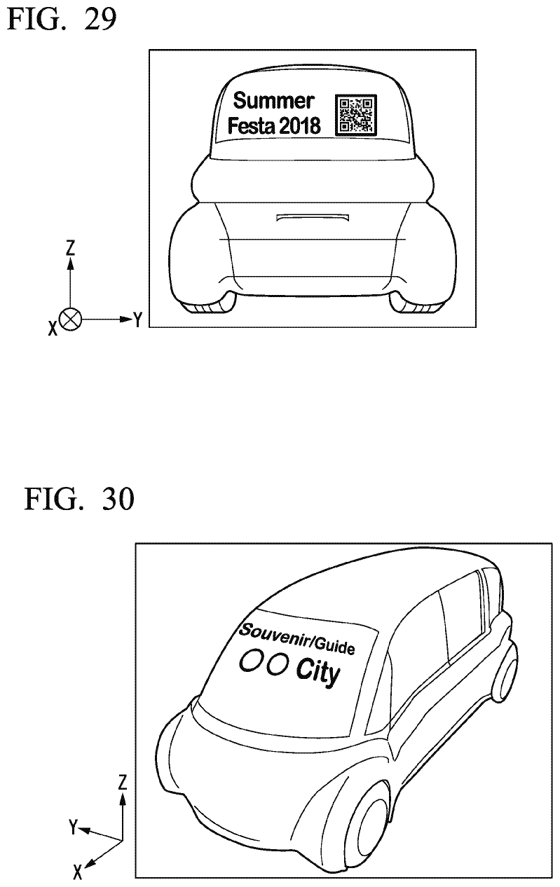

For example, when the vehicle 200 is a vehicle that travels around a predetermined area and provides specialty and sightseeing information of that area (a local circulating sampler vehicle), information representing the local circulating sampler vehicle is displayed on the outside display 272. FIG. 30 is a perspective view of the vehicle 200 having the outside display 272 displaying information representing a local circulating sampler vehicle.

For example, the vehicle 200, the service provider device 600 and the service management device 700 may provide information about services (details of services and information on vehicles providing the services) to a vehicle different from the vehicle 200. The different vehicle is, for example, a vehicle performing automated driving. The different vehicle may acquire the information about services, select any service and vehicle from the acquired information and follow the selected vehicle 200. For example, the aforementioned different vehicle may follow the vehicle 200 traveling toward the event venue.

In addition, when predetermined conditions are satisfied, content displayed when the conditions are satisfied is displayed on the outside display 272. The predetermined conditions are conditions defined on the basis of a surrounding environment state or a relationship between a user and a service provider. For example, when a predetermined product with respect to the service provider S is purchased by a service user, content according to the purchase is displayed on the outside display 272.

According to the above-described second embodiment, the service management device 700 can refer to a corresponding relationship between a user or an operator of a vehicle and content during travel of the vehicle and permit use of the content on the basis of a reference result to realize content display outside the vehicle in a state suitable for the environment of the vehicle.

While forms for embodying the present invention have been described using embodiments, the present invention is not limited to these embodiments and various modifications and substitutions can be made without departing from the spirit or scope of the present invention.

### REFERENCE SIGNS LIST

1 Vehicle control system
200 Vehicle
210 Outside monitoring unit
220 Communication device
230 Navigation device
240 Recommended lane determination device
245 In-vehicle monitoring unit
250 Automated driving control unit
260 Driving power output device
270 Display controller
272 Outside display
274 Requester
276 Acquirer
278, 340 Storage
300 Content providing server
310 Communicator
320 Request receiver
330 Provider

1. A vehicle control system comprising:
an outside display provided on the exterior of a vehicle and configured to display content toward an outside of the vehicle;
a vehicle environment acquirer configured to acquire an environment of the vehicle;
a display controller configured to control display of the content on the outside display on the basis of the environment of the vehicle acquired by the vehicle environment acquirer;
a communicator configured to perform communication with a content providing server;
a requester configured to transmit a content request for requesting the content to the content providing server through the communicator; and
an updater,
wherein the display controller is configured to display content acquired from the content providing server on the outside display on the basis of corresponding information updated in response to the request of the requester and the environment of the vehicle acquired by the vehicle environment acquirer,
the updater is configured to update the corresponding information when the content is acquired from the content providing server, and
the corresponding information is information for determining content to be displayed on the outside display and information in which the content is associated with a user of the vehicle or a driver of the vehicle.

2. The vehicle control system according to claim 1, wherein the vehicle environment acquirer derives a degree of attention on the vehicle, and
the display controller is configured to display second content when the degree of attention exceeds a predetermined value after first content is displayed on the outside display.

3. The vehicle control system according to claim 2, wherein the second content includes advertisement information.

4. The vehicle control system according to claim 1, further comprising an automated driving controller configured to execute automated driving of the vehicle,
wherein the automated driving controller is configured to control a speed of the vehicle in connection with the display of the content by the display controller.

5. The vehicle control system according to claim 1, wherein the display controller is configured to control the display of the content depending on a travel state of the vehicle.

6. The vehicle control system according to claim 1, wherein the display controller is configured to control the display of the content depending on a state of an occupant of the vehicle acquired by the vehicle environment acquirer.

7. The vehicle control system according to claim 1, wherein the vehicle environment acquirer is configured to monitor a line of sight of a person around the vehicle, and
the display controller is configured to change positions of objects included in the content on the basis of the line-of-sight direction of the person around the vehicle acquired by the vehicle environment acquirer.

8. (canceled)

9. A vehicle control method comprising, using a computer:
displaying content to an outside of a vehicle through an outside display provided on an exterior of the vehicle;
acquiring an environment of the vehicle; and
controlling the display of the content on the outside display on the basis of the acquired environment of the vehicle;
communicating with a content providing server;
transmitting a content request for requesting the content to the content providing server;
displaying content acquired from the content providing server on the outside display on the basis of corresponding information updated in response to the request of the requester and the environment of the vehicle acquired;
updating the corresponding information when the content is acquired from the content providing server; and
the corresponding information is information for determining content to be displayed on the outside display and information in which the content is associated with a user of the vehicle or a driver of the vehicle.

10. (canceled)

11. A vehicle management system comprising:
a content controller configured to control content displayable on an outside display provided on an exterior of a vehicle and displaying content toward an outside of the vehicle;
an acquirer configured to acquire environment information of the vehicle from the vehicle; and
a referencer configured to refer to a corresponding relationship between a user of the vehicle or an operator of the vehicle and the content during travel of the vehicle,
wherein the content controller is configured to permit use of the content on the basis of a reference result of the reference; and
an updater,
wherein the content controller is configured to permit use of the content on the basis of a reference result of the referencer and transmit the content or compartment information of the vehicle to an external terminal, and
the updater is configured to update a corresponding relationship between the content and a user of the vehicle or an operator of the vehicle.

12. The vehicle management system according to claim 11, wherein the acquirer is configured to acquire display content being displayed on the outside display and a degree of attention on the vehicle, and
the vehicle management system comprises an updater configured to update the corresponding relationship between the user of the vehicle or the operator of the vehicle and the content.

13. The vehicle management system according to claim 11, wherein the content includes advertisement information.

14. The vehicle management system according to claim 11, wherein the acquirer is configured to acquire information representing whether an automated driving controller of the vehicle is executing automated driving control and information on content display on the outside display of the vehicle, and
the vehicle management system comprises an indicator configured to request change of travel states or routes for the automated driving controller on the basis of the content acquired by the acquirer when the vehicle is executing the automated driving control.

15. The vehicle management system according to claim 11, wherein the indicator further requests change of the travel states or routes depending on the environment information of the vehicle acquired by the acquirer.

16. The vehicle management system according to claim 11, wherein the referencer refers to the corresponding relationship between the content and the user of the vehicle or between the operator of the vehicle and the content depending on a state of an occupant of the vehicle acquired by the acquirer.

17. The vehicle management system according to claim 11, wherein the acquirer is configured to acquire a line of sight of a person around the vehicle associated with content being displayed on the outside display and a position at which the content is displayed on the outside display as environment information of the vehicle, and
the vehicle management system comprises an updater configured to update a corresponding relationship between a user of the vehicle or an operator of the vehicle and the content on the basis of the acquired environment information.

18. The vehicle management system according to claim 11, further comprising:
a communicator configured to perform communication with a content providing server;
a requester configured to cause the communicator to transmit a content request for requesting the content to the content providing server; and
an updater configured to update a corresponding relationship between content acquired from the content providing server and the user of the vehicle or the operator of the vehicle during the travel of the vehicle according to a request from the requester.
